(19) United States
(12) Patent Application Publication
(10) Pub. No.: US 2024/0109783 A1
(43) Pub. Date: Apr. 4, 2024

(54) APPARATUS AND METHOD FOR AMMONIA WASTEWATER REDUCTION

(71) Applicant: Air Products and Chemicals, Inc., Allentown, PA (US)

(72) Inventors: KEVIN RICHARD MADTHA, HERSHAM (GB); GRAEME RICHARD WILSON, SURBITON (GB)

(73) Assignee: Air Products and Chemicals, Inc., Allentown, PA (US)

(21) Appl. No.: 17/956,055

(22) Filed: Sep. 29, 2022

(51) Int. Cl. C01C 1/04

(52) U.S. Cl. CPC C01C 1/0476

(57) ABSTRACT

A process and apparatus for reducing wastewater generated during production of ammonia that can have different levels of production (e.g. ammonia production can vary from 10% to 100% production capacity, etc.) can be configured to minimize or eliminate wastewater from ammonia production. Embodiments can be adapted so that wastewater is stored in a vessel and providable to a scrubber used for processing an ammonia vapor containing stream so that ammonia within that stream can be recovered and mixed with other liquid ammonia product for subsequent storage or use. Embodiments can be implemented so the scrubber stream that may utilize a liquid to perform the scrubbing is recyclable in a way that minimizes or even eliminates formation of a wastewater stream, which can significantly improve process efficiency and provide improved environmental operation as compared to conventional approaches.

### FIELD OF THE INVENTION

The present innovation relates to apparatuses and methods for reducing or avoiding generation of wastewater during the treating of one or more streams output from a facility or plant process unit that manufactures or generates ammonia (NH₃).

### BACKGROUND OF THE INVENTION

Ammonia can be recovered from a purge gas output from an industrial system (e.g. an ammonia synthesis unit or ammonia manufacturing plant). U.S. Pat. No. 5,114,694 discloses an example of such a process that is for use in a “continuous process” (quoting from column 1, line 8 of the patent). Water is utilized in the process described in U.S. Pat. No. 5,114,694, for example, to recover ammonia from a purge gas. As described in columns 4-7 of this patent, liquid water is fed to a tray to contact the purge gas and remove ammonia from it. The water with the ammonia absorbed therein can then be mixed with liquid ammonia product formed from the ammonia production system as discussed in column 7 of this patent.

As explained in U.S. Pat. No. 5,114,694, the disclosed process is for conventional ammonia manufacturing that uses continuous processing that operates at steady state. Such processing relies on conventional ammonia plant feed stream, such as a natural gas-fed reforming process that provides a continuous supply of feed to the ammonia process.

International Publication No. WO 2021/089276 also discloses that ammonia synthesis is “normally regarded as being not suitable to run at partial loads” (quoting from page 2, line 22). WO 2021/089276 discloses a process to maintain ammonia production in a continuous process even when the production is powered by renewable power sources. WO 2021/089276 discloses that a bypass stream be separated from a converter feed line so that this bypass stream can bypass all or some of the items in an ammonia synthesis loop to help permit the ammonia synthesis to occur so that “the reactor is kept in a condition close to the condition of full load, except for the flow rate.” (See e.g. page 6 of WO 2021/089276).

### SUMMARY

For industrial generation of ammonia that may rely on a renewable source of energy, such as wind or solar power, the ammonia manufacturing will not necessarily operate at a continuous, stead-state condition. For instance, solar and wind power operation can result in ammonia manufacturing running between low rates and high rates as a consequence of the sunlight or wind provided on a particular day or other weather issues (e.g. seasonal weather issues, stormy weather, cloudy days, etc.). This type of fluctuation in ammonia manufacturing rates can occur as a result of renewable power providing a variable feed of power for electrolyzers that are used to produce hydrogen that is fed with nitrogen from an air separation unit (ASU) to an ammonia plant for the manufacture of ammonia, for example. Examples of a fluctuation in ammonia production that can occur from renewable power sources can also be appreciated from European Patent Application Publication No. EP 3 957 772 A1 and International Publication No. WO 2022/089820, for example.

Ammonia manufacturing on site may have to ramp production or reduce production significantly to account for a variable supply of hydrogen that may be provided by electrolyzers powered by a renewable power source (e.g. wind power or solar power). The variable rate of hydrogen generation that can occur due to the inconsistent power available from the renewable power source(s) can result in hydrogen production, and thus the ability to form ammonia from that hydrogen, to operate between low and high rates as a consequence of the sunlight or wind provided on a particular day or other weather issues (e.g. seasonal weather issues, stormy weather, cloudy days, etc.).

Some approaches for ammonia manufacturing that attempt to use renewable power sources for powering electrolyzers utilized for formation of hydrogen used in the ammonia manufacturing can require massive hydrogen storage to permit a plant to run at steady state at 100% operation until the hydrogen storage is emptied and the plant has to then be shut down due to lack of sufficient hydrogen. The capital costs associated with such hydrogen storage requirements can be substantial. Further, it still risks a plant shut down and the operational costs and fixed costs associated with having to then re-start plant operations. We have determined that it would be desirable to avoid these type of costs and operational limitations associated with the significant hydrogen storage capacity requirements for such an approach while still permitting operations to occur that can accommodate non-steady state, continuous operational conditions that may have large swings in production rates requiring significant ramping of ammonia production (e.g. ammonia production ranging from 10%-20% of operational capacity to 80%-100% operation capacity, production of ammonia ranging from 10%-25% of operational capacity to 85%-100% operational capacity, etc.).

Fossil fuel based powering systems are often conventionally utilized instead of renewable power based systems. The fossil fuel based systems often use a conventional fossil fuel based power source to power operations and often use natural gas as a feed for the formation of ammonia. These types of conventional systems can avoid lost power that can result from unexpected weather conditions or undesired seasonal changes that affect sunlight or wind availability. However, they also emit significant emissions as well as outputting carbon dioxide and other greenhouse gases that can contribute to global warming.

We have determined that it would be desirable to avoid having to rely on fossil fuels in conjunction with such processing to avoid use of fossil fuels as much as practical for the manufacturing of ammonia. We have also determined that a process similar to the process disclosed in U.S. Pat. No. 5,114,694 to treat one or more vent gas streams output from an ammonia manufacturing facility utilizing hydrogen formed from electrolyzers or other renewable powered equipment (e.g. an ammonia synthesis section of a plant) can result in formation of substantial wastewater flows because the water supply needed for recovering the ammonia via treatment of vent streams or other streams downstream of the ammonia generation unit cannot necessarily be added to liquid ammonia product within the relevant water concentration requirements for the ammonia product due to the unreliable, non-steady state nature of the demand for ammonia and/or production of ammonia. We determined that this is a consequence of the non-steady state operation that can occur as a result of the renewable power source that can be used for making the ammonia in the ammonia manufacturing plant (e.g. ammonia synthesis unit, etc.). For instance, when ammonia production ramps low, there may be too much water for mixing a vent gas scrubbing liquid with the ammonia product output from the ammonia generation unit, and a significant flow of wastewater can then be generated as a result. This wastewater then requires treatment to minimize the ecological impact the wastewater may have on the surrounding environment.

For example, we determined that a vent stream treatment column utilizing a water flow often requires scrubbing water to flow at a flow rate of at least 50% of the maximum operational flow rate due to hydraulic flow issues within the vapor/liquid contacting in the column. During low ammonia manufacturing, such a flow rate can result in substantial water flows that can be fed to a treatment facility to treat wastewater. We determined that this can occur because the minimum scrubbing water flow rate to be fed to the column can far exceed the flow needed for treating a vent gas stream fed to the scrubber for ammonia absorption when ammonia manufacturing is in a low operational state and the ammonia production to which such water can be fed is not sufficiently high enough to accommodate receiving all that water from the treatment column.

We have determined that this type of problem can result in significant wastewater formation and that this problem is unique to ammonia production that utilizes a renewable power source to power at least the hydrogen generation unit of the plant. We also have determined that there is a need to minimize, if not eliminate such wastewater formation to help improve the environmental impact for operations used to make ammonia using one or more renewable energy sources at least for powering the units (e.g. electrolyzers) used to form hydrogen for use in formation of the ammonia. We also determined that the minimization or avoidance of such wastewater can also improve the environmental impact on other areas of the environment by avoiding the need to treat wastewater or generate wastewater that can pose an ecological risk to the environment when treating one or more vent streams downstream of an ammonia generation unit that may output the one or more vent streams as well as one or more ammonia product streams.

In a first aspect, an apparatus for reducing or avoiding creation of wastewater when treating one or more streams output from ammonia manufacturing can be provided. The apparatus can include a scrubber positionable to receive at least one vent gas stream from the ammonia manufacturing. The scrubber can be configured to treat vent gas of the at least one vent gas stream via a scrubbing liquid that is feedable to the scrubber to remove ammonia (NH 3) from the vent gas and output an ammonia recovery stream comprising a liquid that includes water and ammonia and also output at least one waste gas stream. The apparatus can also include a scrubbing fluid storage tank positioned and configured to receive a portion of the ammonia recovery stream output from the scrubber to retain the portion of the ammonia recovery stream therein and subsequently feed the portion of the ammonia recovery stream to the scrubber as the scrubbing liquid.

In operation, the apparatus can be adapted so that some cycles of operation at which ammonia production is high, no portion of the ammonia recovery stream is fed to the scrubbing fluid storage tank or only a small portion of the ammonia recovery stream is fed to the scrubbing fluid storage tank. In other cycles of operation at which ammonia production may be low, a larger portion of the ammonia recovery stream can be fed to the scrubbing fluid storage tank or the feeding of at least a portion of the ammonia recovery stream to the scrubbing fluid storage tank can be initiated (e.g. in event no portion of this stream was fed to the tank during a higher ammonia manufacturing cycle of operation, feeding of a portion of this stream to the tank can be initiated when the ammonia production is decreased to a low ammonia output rate). The apparatus can be provided to accommodate flexible operation so that a portion of the ammonia recovery stream fed to the scrubbing fluid tank can be adjusted to meet operational needs and help keep an ammonia product that is formed from mixing ammonia product from the ammonia manufacturing with the ammonia recovery stream to within a pre-selected ammonia content range and also within a pre-selected water content range. Such operation can also prevent the formation of wastewater that may require treatment, which can provide an improvement in ecological impact as well as an improvement in operational efficiency and cost-effectiveness.

In a second aspect, the apparatus can be provided so that a scrubbing fluid storage tank conduit is positioned between the scrubber and the scrubbing fluid storage tank so that the portion of the ammonia recovery stream is feedable to the scrubbing fluid storage tank and a scrubber feed conduit is positioned between the scrubber and the scrubbing fluid storage tank so that the portion of the ammonia recovery stream is feedable from the scrubbing fluid storage tank to the scrubber as the scrubbing liquid. These conduits can be arranged to include one or more control valves that can be adjusted to control how much of the scrubbing fluid is fed to the scrubbing fluid storage tank and how much of the scrubbing fluid is output from the scrubbing fluid storage tank for being fed to the scrubber.

In a third aspect, the apparatus can also include a pump connected to the scrubber feed conduit so that the scrubbing liquid is outputtable from the scrubbing fluid storage tank to the scrubber.

In a fourth aspect, the apparatus can be configured so that the scrubber and the scrubbing fluid storage tank are positioned and arranged so that wastewater is not formed from operation of the scrubber.

In a fifth aspect, the apparatus can include a mixing device positioned to receive at least one ammonia product stream from the ammonia manufacturing. The at least one ammonia product stream can include a liquid having ammonia within a pre-selected ammonia concentration range (e.g. between 99.2 weight percent (wt %) ammonia to 99.8 wt % ammonia). The mixing device can also be positioned to receive a portion of the ammonia recovery stream from the scrubber to mix with the at least one ammonia product stream and output an ammonia product stream comprising a liquid having ammonia within a pre-selected ammonia content range and water within a pre-selected water content range. The pre-selected ammonia content range can be, for example, between 99.2 wt % ammonia and 99.8 wt % ammonia and the pre-selected water content range can be between 0.2 wt % water and 0.8 wt % water.

The portion of the of the ammonia recovery stream fed to the mixing device can be considered a mixing device portion of the ammonia recovery stream and the portion of the ammonia recovery stream fed to the scrubbing fluid storage tank can be considered a scrubbing fluid storage tank portion. These portions can also be considered a first portion and a second portion of the ammonia recovery stream output from the scrubber.

In a sixth aspect, ammonia storage can be positioned to receive the ammonia product stream output from the mixing device for storage therein. The ammonia storage can include one or more vessels configured to store the ammonia product therein (e.g. liquid ammonia product, an ammonia fluid, etc.). The stored ammonia product can include a liquid having ammonia within a pre-selected ammonia content range and water within a pre-selected water content range.

In a seventh aspect, the apparatus can be arranged so that the scrubber and the scrubbing fluid storage tank are positioned such that a portion of the ammonia recovery stream output from the scrubber is feedable to a mixing device to mix with at least one ammonia product stream received from the ammonia manufacturing and output an ammonia product stream comprising a liquid having ammonia within a pre-selected ammonia concentration range and water within a pre-selected water concentration range. The scrubber and the scrubbing fluid storage tank can also being positioned and arranged so that the portion of the ammonia recovery stream feedable to the scrubbing fluid storage tank and the portion of the ammonia recovery stream feedable to the mixing device are adjustable so that the portion of the ammonia recovery stream fed to the scrubbing fluid storage tank decreases when the at least one ammonia product stream received from the ammonia manufacturing is at a first flow rate and the portion of the ammonia recovery stream fed to the scrubbing fluid storage tank increases when the at least one ammonia product stream received from the ammonia manufacturing is at a second flow rate that is below the first flow rate.

In such an arrangement, the portion of the ammonia recovery stream feedable to the mixing device can also be adjustable so that the flow rate of the portion of the ammonia recovery stream fed to the mixing device increases or is high when the at least one ammonia product stream received from the ammonia manufacturing is at a first flow rate and the portion of the ammonia recovery stream fed to the mixing device decreases or is set to be low when the at least one ammonia product stream received from the ammonia manufacturing is at a second flow rate that is below the first flow rate. The adjustment in the size or proportion of the ammonia recovery stream feedable to the mixing device and the scrubbing fluid storage tank can occur simultaneously (e.g. via simultaneous adjustment of one or more valves, etc.).

The portion of the of the ammonia recovery stream fed to the mixing device can be considered a mixing device portion of the ammonia recovery stream and the portion of the ammonia recovery stream fed to the scrubbing fluid storage tank can be considered a scrubbing fluid storage tank portion. These portions can also be considered a first portion and a second portion of the ammonia recovery stream output from the scrubber.

In some implementations, the first flow rate for the at least one ammonia product stream received from the ammonia manufacturing can be a flow rate at which the ammonia manufacturing operates at a range of 80% capacity to 100% capacity and the second flow rate for the at least one ammonia product stream received from the ammonia manufacturing can be a flow rate at which the ammonia manufacturing operates at a range of 5% capacity to 25% capacity. In other implementations, the first and second flow rates may be different. For example, the first flow rate for the at least one ammonia product stream received from the ammonia manufacturing can be a flow rate at which the ammonia manufacturing operates at a range of 85% capacity to 100% capacity or a range of 75% capacity to 100% capacity and the second flow rate for the at least one ammonia product stream received from the ammonia manufacturing can be a flow rate at which the ammonia manufacturing operates at a range of 5% capacity to 15% capacity, a range of 5% capacity to 20% capacity, or a range that is at an operational capacity that is greater than 0% capacity to an operational capacity level that is less than or equal to 25% capacity.

In an eighth aspect, the scrubber and the scrubbing fluid storage tank can be positioned such that a portion of the ammonia recovery stream output from the scrubber is feedable to a mixing device to mix with the at least one ammonia product stream received from the ammonia manufacturing and output an ammonia product stream comprising a liquid having ammonia within a pre-selected ammonia concentration range and water within a pre-selected water concentration range. The scrubber and the scrubbing fluid storage tank can also be positioned and arranged so that a flow rate for the portion of the ammonia recovery stream feedable to the scrubbing fluid storage tank is adjustable so that the flow rate of the portion of the ammonia recovery stream fed to the scrubbing fluid storage tank decreases when the at least one ammonia product stream received from the ammonia manufacturing is at a first flow rate and the flow rate of the portion of the ammonia recovery stream fed to the scrubbing fluid storage tank increases when the at least one ammonia product stream received from the ammonia manufacturing is at a second flow rate that is below the first flow rate.

In such implementations, the flow rate for the portion of the ammonia recovery stream feedable to the mixing device is also adjustable so that the flow rate of the portion of the ammonia recovery stream fed to the mixing device increases or is high when the at least one ammonia product stream received from the ammonia manufacturing is at a first flow rate and the flow rate of the portion of the ammonia recovery stream fed to the mixing device decreases or is set to be low when the at least one ammonia product stream received from the ammonia manufacturing is at a second flow rate that is below the first flow rate. The adjustment in flow rates of the portions of the ammonia recovery stream feedable to the mixing device and the scrubbing fluid storage tank can occur simultaneously (e.g. via simultaneous adjustment of one or more valves, etc.).

The portion of the of the ammonia recovery stream fed to the mixing device can be considered a mixing device portion of the ammonia recovery stream and the portion of the ammonia recovery stream fed to the scrubbing fluid storage tank can be considered a scrubbing fluid storage tank portion. These portions can also be considered a first portion and a second portion of the ammonia recovery stream output from the scrubber.

In some implementations, the first flow rate for the at least one ammonia product stream received from the ammonia manufacturing can be a flow rate at which the ammonia manufacturing operates at a range of 80% capacity to 100% capacity and the second flow rate for the at least one ammonia product stream received from the ammonia manufacturing can be a flow rate at which the ammonia manufacturing operates at a range of 5% capacity to 25% capacity. In other implementations, the first and second flow rates may be different. For example, the first flow rate for the at least one ammonia product stream received from the ammonia manufacturing can be a flow rate at which the ammonia manufacturing operates at a range of 85% capacity to 100% capacity or a range of 75% capacity to 100% capacity and the second flow rate for the at least one ammonia product stream received from the ammonia manufacturing can be a flow rate at which the ammonia manufacturing operates at a range of 5% capacity to 15% capacity, a range of 5% capacity to 20% capacity, or a range at which the ammonia manufacturing operates at greater than 0% capacity and less than or equal to 25% capacity.

In a ninth aspect, the apparatus can also include a vapor conduit positioned between the scrubbing fluid storage tank and the scrubber to feed vapor from the scrubbing fluid storage tank to the scrubber. In some implementations, the vapor conduit can be connected to a vent stream feed line for feeding that vapor to the scrubber along with the at least one vent gas stream or the vapor conduit can be connected to the scrubber for feeding the vapor from the scrubbing fluid storage tank at an inlet to the scrubber that is separate from an inlet of a vent stream feed line that provides the at least one vent gas stream to the scrubber.

In a tenth aspect, the first aspect of the apparatus can include one or more of the second aspect, third aspect, fourth aspect, fifth aspect, sixth aspect, seventh aspect, eight aspect or ninth aspect. Features of some of these different aspects can be included with the first aspect. In yet another embodiment of the tenth aspect, all the features of the first through ninth aspects can be included in an embodiment of the apparatus.

In an eleventh aspect, an embodiment of the apparatus can be adapted to implement one or more embodiments of a method for reducing or avoiding creation of wastewater when treating one or more streams output from an ammonia manufacturing process. Exemplary embodiments of such a method are discussed below.

In a twelfth aspect, a method for reducing or avoiding creation of wastewater when treating one or more streams output from an ammonia manufacturing process is provided. The method can include feeding at least one vent gas stream from the ammonia manufacturing process to a scrubber configured to treat vent gas of the at least one vent gas stream via a scrubbing liquid that is feedable to the scrubber to remove ammonia (NH 3) from the vent gas and output an ammonia recovery stream comprising a liquid that includes water and ammonia and also output at least one waste gas stream. The method can also include adjustably feeding a portion of the ammonia recovery stream to a scrubbing fluid storage tank based on a flow rate of ammonia product output from the ammonia manufacturing process and feeding the portion of the ammonia recovery stream from the scrubbing fluid storage tank to the scrubber as the scrubbing liquid.

In a thirteenth aspect, the method can be implemented so that the adjustably feeding of the portion of the ammonia recovery stream to the scrubbing fluid storage tank based on the flow rate of ammonia product output from the ammonia manufacturing process includes adjusting the portion of the ammonia recovery stream fed to the scrubbing fluid storage tank so that the portion of the ammonia recovery stream fed to the scrubbing fluid storage tank decreases when the flow rate of ammonia product output from the ammonia manufacturing process is within a first flow rate range and adjusting the portion of the ammonia recovery stream fed to the scrubbing fluid storage tank so that the portion of the ammonia recovery stream fed to the scrubbing fluid storage tank increases when the flow rate of ammonia product output from the ammonia manufacturing process is within a second flow rate range that is below the first flow rate range.

In such implementations, the portion of the ammonia recovery stream feedable to the mixing device can also be adjustable so that the portion of the ammonia recovery stream fed to the mixing device increases or is high when the at least one ammonia product stream received from the ammonia manufacturing is at a first flow rate and the portion of the ammonia recovery stream fed to the mixing device decreases or is set to be low when the at least one ammonia product stream received from the ammonia manufacturing is at a second flow rate that is below the first flow rate. The adjustment in the proportion of the ammonia recovery stream feedable to the mixing device and the scrubbing fluid storage tank can occur simultaneously (e.g. via simultaneous adjustment of one or more valves, etc.).

The portion of the of the ammonia recovery stream fed to the mixing device can be considered a mixing device portion of the ammonia recovery stream and the portion of the ammonia recovery stream fed to the scrubbing fluid storage tank can be considered a scrubbing fluid storage tank portion. These portions can also be considered a first portion and a second portion of the ammonia recovery stream output from the scrubber.

The first flow rate range for the flow rate of ammonia product output from the ammonia manufacturing process can be a flow rate at which the ammonia manufacturing process operates at a range of 80% capacity to 100% capacity and the second flow rate range for the flow rate of ammonia product output from the ammonia manufacturing process being a flow rate range at which the ammonia manufacturing process operates at a range of 5% capacity to 25% capacity in some implementations. In other implementations, the first and second flow rates can correspond to different operational capacity ranges. For example, the first flow rate for the ammonia product output from the ammonia manufacturing process can be a flow rate at which the ammonia manufacturing operates at a range of 85% capacity to 100% capacity or a range of 75% capacity to 100% capacity and the second flow rate for the ammonia product output from the ammonia manufacturing can be a flow rate at which the ammonia manufacturing operates at a range of 5% capacity to 15% capacity, a range of 5% capacity to 20% capacity, or a range at which the ammonia manufacturing operates at greater than 0% capacity and less than or equal to 25% capacity.

In a fourteenth aspect, the method can also include feeding a portion of the ammonia recovery stream output from the scrubber to a mixing device to mix with the ammonia product output from the ammonia manufacturing process to output an ammonia product stream comprising a liquid having ammonia within a pre-selected ammonia concentration range and water within a pre-selected water concentration range. The pre-selected ammonia content range can be, for example, between 99.2 wt % ammonia and 99.8 wt % ammonia or between 99.4 wt % ammonia and 99.8 wt % ammonia and the pre-selected water content range can be between 0.2 wt % water and 0.8 wt % water or between 0.2 wt % water and 0.6 wt % water.

The portion of the of the ammonia recovery stream fed to the mixing device can be considered a mixing device portion of the ammonia recovery stream and the portion of the ammonia recovery stream fed to the scrubbing fluid storage tank can be considered a scrubbing fluid storage tank portion. These portions can also be considered a first portion and a second portion of the ammonia recovery stream output from the scrubber.

In a fifteenth aspect, the adjustably feeding of the portion of the ammonia recovery stream to the scrubbing fluid storage tank based on the flow rate of ammonia product output from the ammonia manufacturing process can include adjusting a flow rate for the portion of the ammonia recovery stream feedable to the scrubbing fluid storage tank so that the flow rate of the portion of the ammonia recovery stream fed to the scrubbing fluid storage tank decreases when the flow rate of ammonia product output from the ammonia manufacturing process is within a first flow rate range and adjusting the flow rate for the portion of the ammonia recovery stream feedable to the scrubbing fluid storage tank so that the flow rate of the portion of the ammonia recovery stream fed to the scrubbing fluid storage tank increases when the flow rate of ammonia product output from the ammonia manufacturing process is within a second flow rate range.

In such implementations, the flow rate for the portion of the ammonia recovery stream feedable to the mixing device can also be adjustable so that the flow rate of the portion of the ammonia recovery stream fed to the mixing device increases or is high when the at least one ammonia product stream received from the ammonia manufacturing is at a first flow rate and the flow rate of the portion of the ammonia recovery stream fed to the mixing device decreases or is set to be low when the at least one ammonia product stream received from the ammonia manufacturing is at a second flow rate that is below the first flow rate. The adjustment in flow rates of the portions of the ammonia recovery stream feedable to the mixing device and the scrubbing fluid storage tank can occur simultaneously (e.g. via simultaneous adjustment of one or more valves, etc.).

The portion of the of the ammonia recovery stream fed to the mixing device can be considered a mixing device portion of the ammonia recovery stream and the portion of the ammonia recovery stream fed to the scrubbing fluid storage tank can be considered a scrubbing fluid storage tank portion. These portions can also be considered a first portion and a second portion of the ammonia recovery stream output from the scrubber.

In some implementations, the first flow rate range for the flow rate of ammonia product output from the ammonia manufacturing process can be a flow rate at which the ammonia manufacturing process operates at a range of 80% capacity to 100% capacity and the second flow rate range for the flow rate of ammonia product output from the ammonia manufacturing process is a flow rate range at which the ammonia manufacturing process operates at a range of 5% capacity to 25% capacity. In other implementations, the first and second flow rates can correspond to different operational capacity ranges. For example, the first flow rate for the ammonia product output from the ammonia manufacturing process can be a flow rate at which the ammonia manufacturing operates at a range of 85% capacity to 100% capacity or a range of 75% capacity to 100% capacity and the second flow rate for the ammonia product output from the ammonia manufacturing can be a flow rate at which the ammonia manufacturing operates at a range of 5% capacity to 15% capacity, a range of 5% capacity to 20% capacity, or a range at which the ammonia manufacturing operates at greater than 0% capacity and less than or equal to 25% capacity.

In a sixteenth aspect, the method can also include feeding a portion of the ammonia recovery stream output from the scrubber to a mixing device to mix with the ammonia product output from the ammonia manufacturing process to output an ammonia product stream comprising a liquid having ammonia within a pre-selected ammonia concentration range and water within a pre-selected water concentration range. The pre-selected ammonia content range can be, for example, between 99.2 wt % ammonia and 99.8 wt % ammonia or between 99.4 wt % ammonia and 99.8 wt % ammonia and the pre-selected water content range can be between 0.2 wt % water and 0.8 wt % water or between 0.2 wt % water and 0.6 wt % water.

The portion of the of the ammonia recovery stream fed to the mixing device can be considered a mixing device portion of the ammonia recovery stream and the portion of the ammonia recovery stream fed to the scrubbing fluid storage tank can be considered a scrubbing fluid storage tank portion. These portions can also be considered a first portion and a second portion of the ammonia recovery stream output from the scrubber.

In a seventeenth aspect, the method can also include feeding a vapor from the scrubbing fluid storage tank to the scrubber. In some implementations, the feeding of the vapor from the scrubbing fluid storage tank to the scrubber can include feeding the vapor from the scrubbing fluid storage tank to a vent stream feed line for feeding that vapor to the scrubber along with at least one vent gas stream or feeding the vapor from the scrubbing fluid storage tank to the scrubber via an inlet to the scrubber that is separate from an inlet of a vent stream feed line that provides at least one vent gas stream to the scrubber.

In an eighteenth aspect, the method can also include feeding at least one ammonia product stream from the ammonia manufacturing process to a mixing device. The at least one ammonia product stream can include a liquid having ammonia at a concentration of between 99.2 weight percent (wt %) ammonia to 99.8 wt % ammonia or between 99.4 wt % ammonia and 99.8 wt % ammonia. The method can also include feeding a portion of the ammonia recovery stream from the scrubber to the mixing device to mix with the at least one ammonia product stream and output an ammonia product stream comprising a liquid having ammonia between 99.2 wt % ammonia and 99.8 wt % ammonia or ammonia between 99.4 wt % ammonia and 99.8 wt % ammonia and water between 0.2 wt % water and 0.8 wt % water or water between 0.4 wt % water and 0.8 wt % water.

The portion of the of the ammonia recovery stream fed to the mixing device can be considered a mixing device portion of the ammonia recovery stream and the portion of the ammonia recovery stream fed to the scrubbing fluid storage tank can be considered a scrubbing fluid storage tank portion. These portions can also be considered a first portion and a second portion of the ammonia recovery stream output from the scrubber.

In a nineteenth aspect, the method can be implemented so that the scrubber and the scrubbing fluid storage tank are positioned and arranged so that wastewater is not generated from operation of the scrubber during operation of the method.

In a twentieth aspect, the method can also include emptying or partial emptying of the scrubbing fluid storage tank when that tank is at a pre-selected capacity threshold or above such a threshold. The emptying of the scrubbing fluid storage tank can include passing the scrubbing fluid to a transportation vessel for transport via a vehicle (e.g. truck, railcar, etc.).

In a twenty-first aspect, the method of the twelfth aspect can be combined with one or more features of at least one of the thirteenth aspect, fourteenth aspect, fifteenth aspect, sixteenth aspect, seventeenth aspect, eighteenth aspect, nineteenth aspect, or twentieth aspect. In yet another embodiment of the twenty-first aspect, all the features of the thirteenth through twentieth aspects can be included in an embodiment of the method of the twelfth aspect.

Other details, objects, and advantages of our process for reducing or avoiding wastewater generated during treatment of ammonia vent gas streams downstream of an ammonia forming unit (e.g. an ammonia synthesis unit), apparatus for reducing or avoiding wastewater generated during treatment of vent gas output from an ammonia generation unit (e.g. an ammonia synthesis section of a facility or plant), system for reducing or avoiding wastewater generated during treatment of vent gas downstream of an ammonia synthesis unit and methods of making and using the same will become apparent as the following description of certain exemplary embodiments thereof proceeds.

### BRIEF DESCRIPTION OF THE DRAWINGS

Exemplary embodiments of methods for reducing or avoiding wastewater formed during the treatment of one or more streams output from one or more ammonia manufacturing processes, apparatuses for reducing or avoiding creation of wastewater when treating one or more streams output from ammonia manufacturing, and systems for reducing or avoiding wastewater generated during treatment of at least one stream output from an ammonia manufacturing facility or unit, and methods of making and using the same are shown in the drawings included herewith. It should be understood that like reference characters used in the drawings may identify like components.

FIG. 1 is a schematic block diagram of a first exemplary embodiment of an apparatus for reducing or avoiding creation of wastewater when treating one or more streams output from ammonia manufacturing that can utilize an exemplary embodiment of the method for reducing or avoiding creation of wastewater when treating one or more streams output from an ammonia manufacturing process (e.g. an ammonia synthesis section of a plant).

FIG. 2 is another schematic block diagram of a portion of the first exemplary embodiment of the apparatus shown in FIG. 1 that provides a more detailed view of an exemplary embodiment of the vent stream treatment device 7 shown in FIG. 1.

FIG. 3 is flow chart of an exemplary process for adjusting flows of the ammonia recovery stream 9 and other related flows used for the vent stream treatment device 7 of the first exemplary embodiment of the apparatus shown in FIGS. 1 and 2.

### DETAILED DESCRIPTION

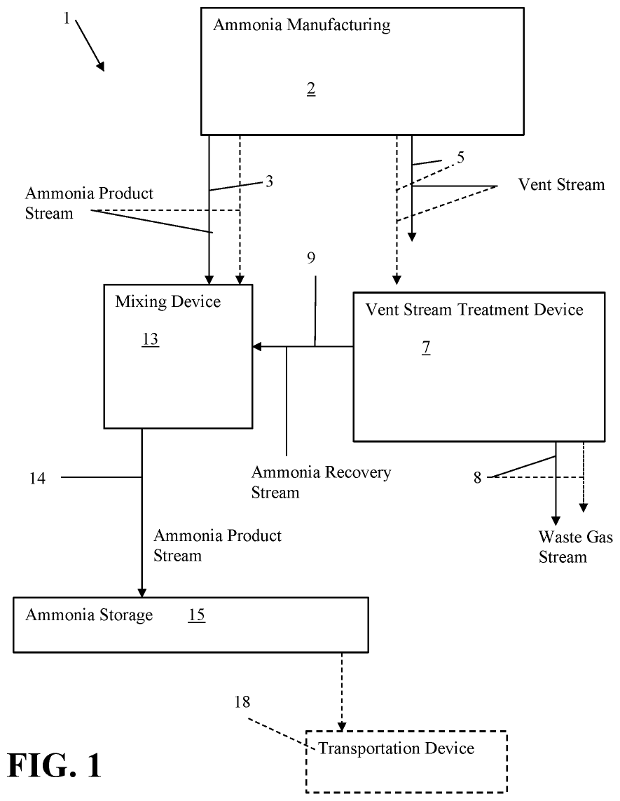

Referring to FIGS. 1-3, a plant 1 can include ammonia manufacturing 2, which can include an ammonia synthesis section of the plant that forms ammonia (NH3) from hydrogen and nitrogen flows fed to the synthesis section of the plant. For example, the hydrogen that is used in the ammonia manufacturing can be provided by an electrolyzer of the plant that forms hydrogen from water or other source of hydrogen and the nitrogen can be provided from an air separation unit of the plant. As another example, the hydrogen and nitrogen flows can be provided by storage vessels that feed those flows to the ammonia synthesis section of the plant. The electrolyzer, air separation unit and the ammonia synthesis section of the plant can all be powered from a renewable resource such as solar and/or wind power so that no fossil fuel based power is provided for operation of the ammonia manufacturing 2.

The ammonia manufacturing 2 can include a hydrogen generation unit having one or more electrolyzers used to generate hydrogen that can be powered by a renewable power source (e.g. wind power and/or solar power), an air separation unit (ASU) that can operate to provide separate nitrogen from air to form a feed of nitrogen, and an ammonia synthesis section that can receive hydrogen from the hydrogen generation unit and nitrogen from the ASU to form at least one ammonia product stream 3 as well as at least one vent stream 5.

The ammonia manufacturing 2 can output one or more ammonia product streams 3 that include ammonia (NH3). The ammonia product streams 3 can include liquid NH3 that is ammonia rich. For instance, the ammonia product stream(s) 3 can have a NH3 content of 100 wt % NH3 or an NH3 content of between 100 wt % NH3 and 99.9 wt % NH3. It is possible the product stream(s) 3 can include some trace amounts of other impurities, but such impurities would tend to be at de minimis levels, if present.

The ammonia manufacturing can also generate one or more vent streams 5. Each vent stream 5 can include ammonia as well as other components that is output as one or more off gas streams from the ammonia manufacturing. For example, the vent stream(s) 5 can include gaseous ammonia as well as other gaseous constituents, such as argon, nitrogen, or hydrogen. In ammonia manufacturing that may utilize flashing of streams of nitrogen and hydrogen to form the ammonia, the vent stream(s) 5 may include some ammonia, nitrogen, and hydrogen, for example. To avoid or minimize loss of ammonia, the one or more vent streams 5 can be fed to a vent stream treatment device 7.

The vent stream treatment device 7 can treat the vent gas of the vent stream(s) 5 to recover ammonia and output an ammonia recovery stream 9. A vent stream treatment device feed conduit can be connected between the ammonia manufacturing 2 and the vent stream treatment device 7 to feed the vent stream(s) 5 to the vent stream treatment device 7. The ammonia recovery stream 9 output from the vent stream treatment device 7 can include 0 wt % to 40 wt % ammonia and 100 wt % to 60 wt % water, can include 0 wt % to 30 wt % ammonia and 100 wt % to 70 wt % water, or can include another suitable ammonia and water concentration range (e.g. include a concentration of 0 wt % to 35 wt % ammonia and 100 wt % to 65 wt % water, include a concentration of greater than 0 wt % to 25 wt % ammonia and less than 100 wt % water to 75 wt % water, a concentration of greater than 0 wt % to 30 wt % ammonia and less than 100 wt % water to 70 wt % water, etc.). The ammonia recovery stream 9 can be output as a liquid or be a flow of fluid that includes liquid and some vapor.

The vent stream treatment device 7 can also output at least one waste gas stream 8. For instance, a first waste gas stream 8 can be formed and output from the scrubber 20 of the vent stream treatment device 7 to be fed to a flare or a warm flame as a fuel for being combusted or to be utilized as a recycled gas for use in other plant processes (e.g. a heat exchanger cooling or heating medium, an adsorber regeneration flow, etc.).

The plant can also be operated so that there is at least one other waste gas stream 8 formed from the at least one vent stream 5. For instance, a second waste gas stream 8 can be output to the atmosphere as an off gas stream that is vented to flare or vented to atmosphere. This second waste gas stream 8 can be split or separated prior to the vent gas being fed to a scrubber 20 to undergo ammonia recovery treatment therein for example. For example, a vent stream control valve 33d can be provided in a vent stream conduit that is connected to a scrubber feed conduit so that this valve 33d can be opened at least partially to permit the second waste gas stream 8 to be split from a vent stream flow passing through the scrubber feed conduit to the scrubber 20 to form the second waste gas stream 8 for venting or to passing to a flare. The vent stream control valve 33d can also be adjusted to a closed position so that an entirety of the vent stream(s) 5 output from ammonia manufacturing 2 is fed to the scrubber 20. In operational conditions when the vent stream control valve 33d is closed, the first waste gas stream 8 formed via the scrubber 20 may be the only waste gas stream 8 formed from the one or more vent streams 5.

The ammonia recovery stream 9 output from the vent stream treatment device 7 can be fed to a mixing device 13 that also receives the one or more ammonia product streams 3 output from the ammonia manufacturing 2. A mixing device feed conduit can be connected between the vent stream treatment device 7 and the mixing device 13 to convey the ammonia recovery stream 9 to the mixing device 13. An ammonia product stream feed conduit can also be positioned between the ammonia manufacturing 2 and the mixing device 13 to feed the one or more ammonia product streams 3 to the mixing device 13. The mixing device 13 can mix these product and recovery streams 3, 9 together to form an ammonia product stream 14. The ammonia product stream 14 can include ammonia in a range of 99.8 wt % NH3 to 99.4 wt % NH3 and water in a range of 0.2 wt % water to 0.6 wt % water or can include ammonia in a range of 99.8 wt % NH3 to 99.5 wt % NH3 and water in a range of 0.2 wt % water to 0.5 wt % water. In other embodiments, the ammonia product stream 14 can include ammonia and water in another set of suitable ranges.

The mixing device 13 can be a device that is able to mix the one or more ammonia product streams 3 with at least one ammonia recovery stream 9 output from the vent stream treatment device 7. An example of such a mixing device 13 can include an in-line mixer, a mixing vessel, or other type of suitable mixing device 13.

The ammonia product stream 14 output from the mixing device 13 can be fed to at least one vessel for ammonia storage 15 via an ammonia storage feed conduit positioned between the mixing device 13 and the ammonia storage 15. The ammonia stored in the ammonia storage 15 can fed to one or more tankers of at least one transportation device 18 (e.g. a truck, a boat, a railcar, etc. that can transport one or more tanks of the ammonia to another site for use by another user). One or more conduits can be utilized to transport to the ammonia from the ammonia storage for feeding the transportation device 18.

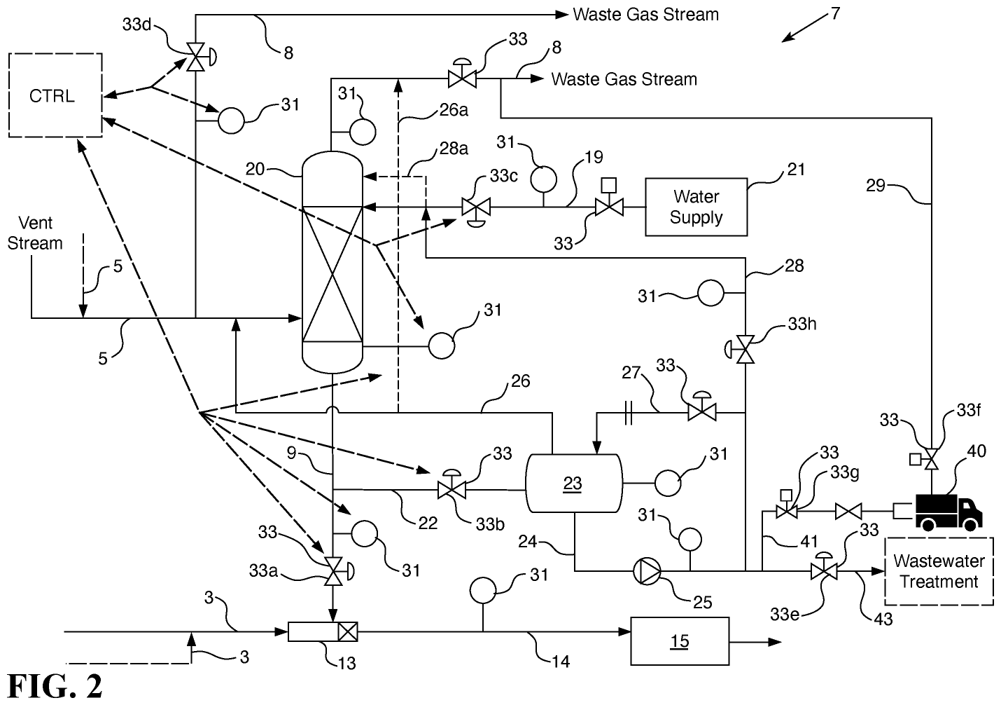

The vent stream treatment device 7 can be configured so that the ammonia recovery stream 9 can be formed without generating any wastewater or by minimizing the formation of wastewater so wastewater is only generated in extreme, unusual situations (e.g. the plant operates at a low operational rate or a turndown operational condition for an extended period of time). An example of an arrangement for the vent stream treatment device 7 may best be appreciated from FIG. 2.

For example, a vent stream 5 that includes ammonia output from ammonia manufacturing 2 can be fed to a scrubber 20 of the vent stream treatment device 7. The scrubber 20 can utilize water from a water feed stream 19 to scrub the gas of the vent stream and absorb the ammonia from the vent stream(s) 5. The water feed stream 19 fed to the scrubber can include liquid water from a water supply 21 and/or can include liquid from a liquid scrubbing stream passed through the scrubber feed conduit 28 from a scrubbing fluid storage tank 23 that can include water and ammonia.

The water supply 21 can be configured to supply a demineralized water to the scrubber 20. This water can be mixed with fluid from the storage tank 23 before the fluid is fed to the scrubber 20. Alternatively, the water from the water supply 21 and the fluid from the tank 23 can be fed to the scrubber via separate inlets so that a water feed stream 19 and a scrubbing fluid stream 28a from the scrubbing fluid storage tank 23 are passed into the scrubber 20 at separate inlets (as indicated in broken line 28a in FIG. 2).

The liquid scrubbing fluid flow(s) that can include water and ammonia can be fed adjacent to the top of the scrubber 20 to flow in countercurrent arrangement with the gaseous vent stream 5 fed adjacent to the bottom of the scrubber 20. The scrubber 20 can output the ammonia recovery stream 9, which can include liquid that has ammonia and water. The ammonia within the ammonia recovery stream 9 can include ammonia absorbed from the one or more gaseous vent streams 5 fed to the scrubber 20. The scrubber 20 can also output at least one waste gas stream 8, which can be vented, sent to a flare, or fed to another plant device (e.g. heat exchanger, etc.). The waste gas stream 8 can be a gas stream that has less ammonia in it (or no ammonia therein) based on the liquid flow scrubbing the vent stream 5 via the scrubber 20. The waste gas stream 8 can be output from the scrubber 20 adjacent to the top of the scrubber 20 and the ammonia recovery stream 9 can be output adjacent to the bottom of the scrubber 20.

The scrubber 20 can utilize one or more stages that can include trays or other mechanisms to facilitate scrubbing so that the liquid fed to the scrubber 20 contacts or otherwise sufficiently engages with the gas of the vent gas stream(s) 5 for removing ammonia from the gas so the gaseous ammonia is captured within the liquid to form the ammonia recovery stream 9. The gas output from the scrubber 20 as a first waste gas stream 8 therefore has less ammonia therein than the vent gas stream 5 included when it was fed to the scrubber 20 (e.g. the waste gas stream 8 has no ammonia or a significantly smaller amount of ammonia than the vent stream 5).

In addition to the scrubber 20, the vent stream treatment device 7 includes the scrubbing fluid storage tank 23, which can be positioned to receive a portion of the ammonia recovery stream 9 output from the scrubber 20 during operation of the vent stream treatment device 7. A scrubbing fluid storage tank conduit 22 can be positioned to connect the scrubber 20 to the scrubbing fluid storage tank 23 so that at least a portion of the ammonia recovery stream 9 can be fed to the scrubbing fluid storage tank 23 when a control valve 33b of the scrubbing fluid storage tank conduit 22 is adjusted to an open position. If the control valve 33b of the scrubbing fluid storage tank conduit 22 is closed, the entirety of the ammonia recovery stream 9 can be fed to the mixing device 13. The control valve 33b of the scrubbing fluid storage tank conduit 22 can include various open positions to adjust the proportion of the ammonia recovery stream 9 that is fed to the scrubbing fluid storage tank 23. This adjustment can operate in tandem with adjustment of a control valve 33a of the mixing device feed conduit that can be connected between the scrubber 20 and the mixing device 13 to convey the ammonia recovery stream 9 to the mixing device 13 to help control how much of the ammonia recovery stream 9 is fed to the mixing device 13 and how much of it is fed to the scrubbing fluid storage tank 23. The control valves 33a, 33b, as well as other control valves 33 can be adjusted to different open positions or closed positions at the same time or at different times during operation.

In operation, the mixing device 13 can receive 0% to 100% of the ammonia recovery stream 9 and the scrubbing fluid storage tank 23 can receive the balance of the ammonia recovery stream 9 (e.g. the scrubbing fluid storage tank can receive 100% of the ammonia recovery stream 9 when the mixing device 13 receives 0% of it to 0% of the ammonia recovery stream 9 when the mixing device receives 100% of that stream). This proportion of the flow of the ammonia recovery stream 9 fed toward the mixing device 13 and fed to the scrubbing fluid storage tank 23 can be adjusted during operation to account for water content and ammonia content specifications for the mixed product stream 14 so that the ammonia and water within the product stream 14 are within the pre-selected ammonia and water concentrations for the product stream 14 output from the mixing device 13.

The adjustment in what proportion of the ammonia recovery stream 9 is fed to the scrubbing fluid storage tank 23 and what proportion is fed to the mixing device 13 can be controlled via adjustment of the control valves 33a and 33b. Operation of other elements can also be adjusted to adjust what proportion of the ammonia recovery stream 9 is fed to the scrubbing fluid storage tank 23 and what proportion is fed to the mixing device 13.

The scrubbing fluid storage tank 23 can be a sized vessel that is connected to a number of conduits for providing fluid that includes ammonia and water therein to the scrubber 20. These conduits can include a vapor conduit 26 that can be positioned between the scrubber 20 and the scrubbing fluid storage tank 23 to provide vapor that may form while the fluid is within the tank 23 to the scrubber 20 so that vapor is fed to the scrubber along with the vapor of the one or more vent streams 5 (e.g. the vapor conduit 26 can connect to the vent stream feed conduit for feeding that vapor to the scrubber 20 or can connect to the scrubber 20 for feeding to the scrubber 20 at a separate inlet to the scrubber 20, etc.). The vapor conduit 26 can also, or alternatively, include a vent conduit segment 26a through which the vapor from the tank 23 is passable to feed the vapor to vent it or feed the vapor to a flare as a part of a second waste gas stream 8 (e.g. as shown in broken line in FIG. 2).

The vent conduit segment 26a can be provided as an option for passing vapor from the tank 23 to another location instead of the scrubber 20. The vapor conduit 26 can include an adjustable control valve connected between the vent conduit segment 26a and another portion of the vapor conduit 26 to provide such vapor routing options. Or the vent conduit segment 26a may not be provided. As yet another option, the vent conduit segment 26a can be provided such that the vapor conduit 26 does not include any pathway for feeding any of the vapor to the scrubber 20 (e.g. the vapor from the tank 23 is only passed to vent as a waste gas stream 8 and is not fed to the scrubber 20).

The vapor that is formed in the tank 23 and output via the vapor conduit 26 and/or vapor segment 26a of the vapor conduit 26 can include ammonia therein (e.g. be mostly ammonia, be entirely ammonia, be a mixture of water vapor and ammonia vapor, etc.). The tank outlet for the vapor conduit 26 for outputting this vapor from the scrubbing fluid storage tank 23 can be positioned at or adjacent to the top of the tank.

Additionally, there can be an ammonia scrubbing liquid fluid outlet conduit 24 that can be positioned at or adjacent to the bottom of the tank that is connected to a pump 25 for feeding the liquid scrubbing fluid retained within the scrubbing fluid storage tank 23 to the scrubber 20 and/or other destinations. The pump 25 can be connected to the ammonia scrubbing outlet conduit 24 to drive the liquid scrubbing fluid from the tank 23 to one or more locations via one or more scrubbing fluid feed conduits.

For example, the pump 25 can help facilitate the flow of the liquid scrubbing fluid from the tank 23 to the scrubber 20 via a scrubber feed conduit 28 positioned between the tank 23 and the scrubber 20 and/or the pump 25 and the scrubber 20. A control valve 33h can be attached to or included in the scrubber feed conduit 28 so that this valve 33h can be adjusted to divert at least a portion of the liquid scrubbing fluid provided via the tank 23 back to the tank 23 as well via a scrubbing liquid return conduit 27 that can be connected to the scrubber feed conduit 28. For example, the pump 25 may drive a flow of the scrubbing liquid fluid to toward the scrubber 20, but only a portion of the flow may be suitable for the scrubber to form the ammonia recovery stream 9.

The control valve 33h of the scrubber feed conduit 28 can be adjusted so that a portion of the liquid scrubbing fluid is fed to the scrubber to meet the desired flow rate of scrubbing liquid fluid for the scrubber 20 and a remaining portion of the liquid scrubbing fluid is returned to the tank 23 via the return conduit 27. For instance, the control valve 33 of the scrubber feed conduit 28 can be adjustable so that (i) 100% of the fluid output from the pump 25 can be fed to the scrubber 20 and 0% of the fluid output from the pump 25 is passed into the return conduit 27, (ii) 0% of the fluid output from the pump 25 can be fed to the scrubber 20 and 100% of the fluid output from the pump 25 is passed into the return conduit 27, or (iii) less than 100% and more than 0% of the fluid output from the pump 25 can be fed to the scrubber 20 and the balance is provided back to the tank via the return conduit 27.

The rate of the liquid scrubbing fluid fed to the scrubber 20 can be sufficient so that no water from a water supply 21 is needed. In such situations, a control valve 33c of the conduit of the water feed stream 19 can be adjusted to a closed position so that only the liquid from the tank 23 is provided to the scrubber 20 as the scrubbing liquid used for scrubbing of the vent stream(s) 5.

Use of liquid from the tank 23 without any fresh water from the water supply 21 can, in some situations, result in an ammonia slip environment. For instance, in situations where the ammonia concentration within the liquid from the tank 23 is relatively high (e.g. over 15 wt % ammonia and less than 40 wt % ammonia or over 20 wt % ammonia and less than 40 wt % ammonia, etc.), the liquid passed into the scrubber 20 via the tank 23 may have too much ammonia therein to sufficiently scrub the vent stream(s) 5 fed to the scrubber to remove all the ammonia from the at least one vent stream 5. In such a situation, some ammonia may slip out of the scrubber in the waste gas stream 8 output from the scrubber 20. How much ammonia slips out of the scrubber 20 can depend on the concentration of ammonia in the scrubbing liquid fed to the scrubber 20, ammonia within the vent stream(s) 5, and flow rates of the scrubbing liquid and ammonia fed to the scrubber.

Typically, ammonia slip is desired to be avoided. However, it may be desired in some situations to permit ammonia slip to occur so that the tank 23 level of scrubbing liquid therein can be reduced to below a pre-selected maximum fill level so that wastewater generation can be avoided. Ammonia slip may also be permitted or desired if it can permit operations to continue in more profitable or economical manner while also avoiding generation of wastewater that requires wastewater treatment.

In other situations, there may be a need for some water from the water supply 21 (e.g. at start-up of the scrubber 20 when the tank 23 may not have sufficient liquid stored therein, at an operational condition where the tank does not have sufficient stored liquid to meet the scrubber's operational demand for scrubbing liquid, in a situation where an ammonia slip condition is to be avoided, etc.). In such situations, the water from the water supply 21 can be fed along with scrubbing fluid from the tank 23 or can be exclusively fed to the scrubber 20 without any scrubbing fluid from the tank 23 being fed to the scrubber 20.

For example, the design of the system can be set so that water from the water supply 21 is always to be included and fed to the scrubber 20 at least at a pre-selected minimum flow rate and fed to the scrubber 20 to help avoid ammonia slip conditions in which some ammonia may be lost to the first waste gas stream 8 output from the scrubber 20. In those situations, liquid water from the water supply 21 can be provided via the conduit of the water feed stream 19 that can provide water from the water supply 21 to the scrubber 20. The water flow from the water supply 21 can be fed separate from the liquid scrubber fluid provided from the scrubbing fluid storage tank 23 via the scrubber feed conduit 28 via separate scrubber liquid inlets of the scrubber 20 or can be mixed with that scrubbing fluid from the storage tank 23 before that mixed flow is fed to the scrubber 20 via the same scrubber liquid inlet. In situations where a single liquid inlet for the scrubbing liquid may be utilized for the scrubber 20, it should be appreciated that the mixing of the water from the water supply 21 and scrubbing liquid from the tank 23 may not always occur and only water or only the scrubbing liquid from the tank 23 may be used (e.g. when water from the water supply 21 is not needed when sufficient liquid can be provided from the tank 23 or when the tank 23 is empty or at a pre-selected minimum capacity and only water from the water supply 21 may be utilized as the scrubbing liquid, such as in a start-up condition, etc.).

The scrubbing fluid storage tank 23 and pump 25 can also be connected to a wastewater treatment feed conduit 43 for feeding liquid scrubbing fluid within the tank 23 to a wastewater treatment facility and/or a transportation vehicle feed conduit 41 for feeding liquid scrubbing fluid from the tank 23 to a transportation vessel 40 to be transported off-site to another location. These options may be available for use only as a safety precaution in the event of unexpected or extreme situations. For instance, in a situation where the plant may operate at an extremely low production rate for a long period of time due to an unexpected or extreme weather condition that prevents the renewable power source from powering operations of the plant at a higher level, the tank 23 may become close to filled or fully filled and no longer be utilizable and the entirety of the ammonia recovery stream 9 may not be able to be provided for mixing with the product stream(s) 3 while keeping the ammonia product stream 14 within applicable pre-specified acceptable ammonia and water content ranges. In such a condition, content of the tank 23 may need to be reduced (e.g. a partial emptying may be needed). Such a reduction in level of fluid stored in the tank 23 can occur by pumping the fluid stored in the tank 23 to a water treatment facility via the water treatment feed conduit 43 and/or feeding the fluid from the tank to a transportation vessel 40 so via the transportation vehicle feed conduit 41 so that the fluid can be removed from the tank 23 and either stored for later use or transported off site for further use of disposal.

It should be appreciated that one or more adjustable valves 33 can be included in the water treatment feed conduit 43 and/or the transportation vehicle feed conduit 41 to prevent the flow of fluid through these conduits and/or permit the flow of fluid through these conduits. Each such valve 33 may only be adjusted to an open state for emptying the tank 23 and may otherwise be in a closed position, for example. For instance, a wastewater treatment supply control valve 33e can be connected to water treatment feed conduit 43 and/or a vehicle transport supply control valve 33g can be connected between the tank 23 and the transportation vehicle feed conduit 41.

There can also be a waste gas stream vehicle transport feed conduit 29 that can be connectable between the scrubber 20 and a transportation vessel 40 so that fluid fed to a transportation vessel of vehicle can be fed to a waste gas stream 8 to avoid over pressurization of the transportation vessel being filled. A vehicle transport feed conduit control valve 33f can be included in the waste gas stream vehicle transport feed conduit 29 that can be adjusted between an open position and a closed position. When the vehicle transport feed conduit control valve 33f is in the open position, fluid from within a transportation vessel 40 of a vehicle can be passed to a waste stream 8 for feeding to a flare or a plant element via the waste gas stream vehicle transport feed conduit 29 to avoid an over pressurized condition in the vehicle container used for transport of the scrubbing fluid. When the vehicle transport feed conduit control valve 33f is in the closed position, no such flow of scrubbing fluid out of the vehicle transport container may occur.

A controller CTRL as well as various sensor elements 31 (e.g. level detectors, level controllers, level sensors, temperature sensors, pressure sensors, flow rate sensors, mass flow sensors, etc.) can be included in the apparatus to monitor one or more operational conditions of the apparatus. Sensors 31 can be included or connected to conduits, the scrubber 20, the scrubbing fluid storage tank 23, and other components as well as other process units of the apparatus. For example, a controller CTRL can be communicatively connectable to the pump 25, valves 33 and/or sensors 31 to monitor operations of the vent stream treatment device 7 and facilitate or monitor the opening and closing of valves 33 as well as controlling the operation of the pump 25 and mixing of the ammonia recovery stream 9 with one or more ammonia product streams 3 from the ammonia manufacturing to form the ammonia product stream 14 for providing to ammonia storage 15. Sensors can also be included in the mixing device 13 and in conduits through which product streams 3 and 14 pass to monitor flow rates, ammonia content and/or water content of the streams and/or to monitor pressure and/or temperature of the streams.

The controller CTRL can include hardware that includes a processor, non-transitory memory, and at least one transceiver to facilitate such operations. The controller CTRL can be connected to various different flow, pressure and level controllers (e.g. sensors 31) as well as other sensors 31. An automated process control program stored in the memory of the controller CTRL can be run by the processor and can utilize data it receives from the sensors 31 to perform its operations. The controller CTRL can also be communicatively connected to one or more input devices and one or more output devices to facilitate an output of data to an operator and also receive input from an operator. For example, the controller CTRL can be connectable to a display, a keyboard and a mouse and/or a laptop computer, personal computer, smart phone, or tablet of an operator to facilitate the providing of output and receipt of input.

In some embodiments, the controller CTRL, valve and sensor arrangement can be included in a distributed control system (DCS). Various flow, pressure and level controllers can be provided to maintain the process to meet pre-defined set points and alarms can be defined so that alarms are communicated to an operator for warning of the process violating these set points. The warnings can be provided to the controller CTRL, which may facilitate communication of the warnings audibly and/or visually to the operator and also facilitate the providing of input received from the operator to other elements of the DCS.

The operation of the apparatus referring to FIGS. 1-3 can include adapting how the ammonia recovery stream 9 is conveyed and how scrubbing fluid from the tank 23 and water supply 21 are utilized based on a variable rate of ammonia provided as one or more ammonia product streams 3 from the ammonia manufacturing 2. This variable rate of ammonia production can occur as a result of the ammonia manufacturing being entirely powered by renewable power sources (e.g. solar power and/or wind power, etc.) and having weather or other power generation conditions change that prevent full powering of ammonia production such that ammonia production must occur at a lower production capacity.

For example, liquid ammonia can be provided from the ammonia manufacturing 2 as at least one ammonia product stream 3 from the ammonia manufacturing 2 at a high rate (e.g. 100% capacity or 90%-100% of the production capacity rate). This high rate of the liquid ammonia output in the ammonia product stream(s) 3 can be, for example, a first flow rate of liquid ammonia that is fed to the mixing device 13. The first flow rate of the liquid ammonia product from the one or more ammonia product streams 3 fed to the mixing device can be a flow rate of ammonia product output from the ammonia manufacturing process when the ammonia manufacturing process operates at a range of 80% capacity to 100% capacity.

At this higher first flow rate of ammonia from the ammonia manufacturing 2, the ammonia product stream(s) 3 can be mixed with the ammonia recovery stream 9 and receive a first flow rate of water from the ammonia recovery stream 9 while still permitting the product stream 14 output from the mixing device to have an ammonia content within a pre-selected minimum ammonia concentration (e.g. 99.2 wt % ammonia, or 99.4 wt % ammonia, etc.). The amount of scrubbing liquid output from the tank 23 to the scrubber 20 can be increased when this operational condition has been determined to exist or detected to increase the rate at which the tank fluid is being emptied to work to provide more of the liquid that includes water and ammonia from within the tank to the scrubber 20 and the proportion of the ammonia recovery stream 9 output to the mixing device 13 (instead of being sent to the tank 23) can also be adjusted to increase the proportion of the ammonia recovery stream 9 being provided to the mixing device so that more water as well as more ammonia from the scrubber is being output to the mixing device 13 for mixing therein to form the product stream 14 for being output to ammonia storage 15. At least one of increasing the flow rate of scrubbing liquid being fed to the scrubber 20 via the tank 23 and scrubber feed conduit 28 and the adjustment of the proportion of the ammonia recovery stream 9 being sent to the mixing device 13 can be utilized to decrease the amount of fluid stored in tank 23 and also increase the water content within the ammonia product 14 being output from the mixing device while still controlling the water content of the ammonia product 14 so it stays within a pre-specified content range (e.g. the product stream 14 includes water at no more than 0.8 wt % and no less than 0.2 wt % or no more than 0.6 wt % and no less than 0.2 wt %, etc.). It should be appreciated that the increased rate of output of fluid provided by the tank 23 can be provided by increasing the pump's operation to drive a greater flow of fluid and/or adjusting valves within the scrubbing liquid return conduit 27 and/or scrubber feed conduit 28 to increase the portion of the scrubbing fluid that is passed into scrubber feed conduit 28 and decrease the flow of liquid returning to the tank via return conduit 27.

The amount of liquid scrubbing fluid from the tank 23 that is output to the scrubber 20 can be at a first rate that can be a high rate of output to help empty the tank 23 at a faster rate to increase its capacity to store fluid from the ammonia recovery stream 9 output from the scrubber 20 during lower ammonia production time periods. The output liquid, however, can be controlled so it is not so high a rate that the amount of water included within the ammonia product stream 14 exceeds a pre-selected maximum water concentration (e.g. 0.8 wt % water, 0.6 wt % water, 0.4 wt % water, etc.). The pump 25 and the one or more valves 33 of the water feed stream 19 for the water supply 21 and the scrubber feed conduit 28 can be adjusted to facilitate the flow of the liquid scrubbing fluid from the tank 23 to the scrubber 20. The flow rate of the liquid scrubbing fluid from the tank 23 to the scrubber 20 (and use of water from water supply 21 as may be needed for supplementing that flow of scrubbing liquid to a flow rate needed by the scrubber 20) can be adjusted to help to keep the tank's level of scrubbing liquid retained therein as low as possible or within a pre-selected high ammonia production capacity storage tank filled threshold level range (e.g. at least 5%-10% full, at least 5%-10% full and not more than 25% full, at least 15% full and not more than 20% full, at least 10% full and not more than 20% full, at least 5% full and no more than 15% full, etc.) while also permitting the mixing device 13 to be able to output ammonia product stream 14 with ammonia and water within their pre-specified content ranges during this high ammonia production time period of operation.

It should be appreciated that the providing of a higher rate of scrubbing liquid from the tank 23 can result in an increased flow rate of liquid within the ammonia recovery stream 9 due to the increased rate of liquid being fed to the scrubber 20. This increased rate of overall liquid fed to scrubber 20 as a scrubbing liquid can help facilitate an increase in the flow rate of liquid of the ammonia recovery stream 9 being fed to the mixing device 13 such that there is an increase in a rate of water being ultimately fed to the mixing device 13 via the ammonia recovery stream 9 output from the scrubber 20. This increased water output to the mixing device 13 can be performed to help empty the tank 23 or reduce its contents so its storage capacity is increased while avoiding providing too much water such that the ammonia product stream 14 output from the mixing device 13 has water and ammonia concentrations within their pre-specified content ranges (e.g. 99.8-99.5 wt % ammonia, 0.2-0.5 wt % water, 99.8-99.2 wt % ammonia, 0.2-0.8 wt % water, etc.)

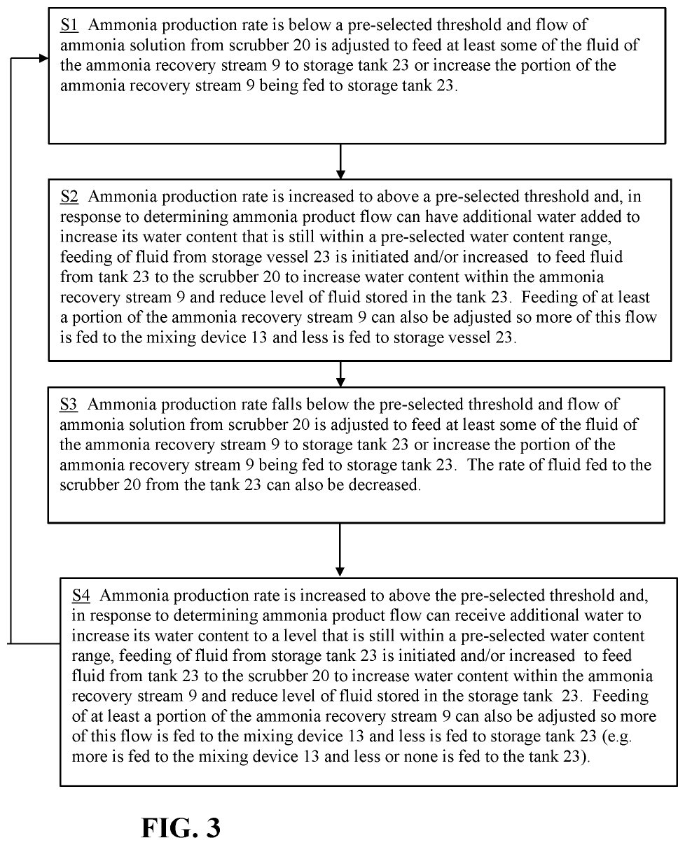

At some point in time, operational output of ammonia from the ammonia manufacturing 2 can decrease to a second flow rate that is lower than the first flow rate (e.g. drop to a substantially lower output rate of 10% of its operational capacity, drop to a lower output rate in a range of 10% to 30% of its operational capacity or drop to an output rate in a range of 10% to 50% of its operational capacity, drop to an output rate that is below 60% of its operational capacity, etc.). This can occur as a consequence of reduced power availability from renewable power sources (solar, wind, etc.) that may arise due to weather conditions, for example. As a result, the liquid ammonia flow rate of the ammonia product stream(s) 3 fed to the mixing device 13 can be below a pre-selected threshold. Such a condition can be appreciated from step S1 of FIG. 3, for example. This lower flow rate of the liquid ammonia product from the one or more ammonia product streams 3 fed to the mixing device can be a second flow rate of ammonia product output from the ammonia manufacturing process when the ammonia manufacturing process operates at a range of 5% of its operational capacity to 25% of its operational capacity, a range of 10% of its operational capacity to 30% of its operational capacity, or a range of 10% of its operational capacity to 50% of its operational capacity, at a range that is below 60% of its operational capacity, for example.

In response to the detection or determination of such a situation where the ammonia product stream(s) 3 are at the second flow rate within a second flow rate range that is lower than the first higher flow rate range, the flow of the scrubbing liquid that is output from the tank 23 to the scrubber 20 can be adjusted so at least some of the fluid of the ammonia recovery stream 9 is fed to the tank 23, there is an increase in a flow rate of the portion of the ammonia recovery stream 9 being fed to the tank 23, or there is an increase in the portion of the ammonia recovery stream 9 that is fed to the storage tank 23.

At this lower second flow rate of ammonia from the ammonia manufacturing 2, the ammonia product stream(s) 3 can be mixed with the ammonia recovery stream 9 while still permitting the product stream 14 output from the mixing device to have an ammonia content within a pre-selected ammonia concentration range (e.g. 99.2 wt % ammonia to 99.8 wt % ammonia, or 99.4 wt % ammonia to 99.8 wt % ammonia, 99.6 wt % ammonia to 99.8 wt % ammonia, etc.). The amount of scrubbing liquid output from the tank 23 to the scrubber 20 can be decreased when this operational condition has been determined to exist or detected to decrease the rate at which the tank fluid is being emptied from the tank 23 to work to provide less of the liquid that includes water and ammonia from within the tank to the scrubber 20 so that the overall flow of water within the ammonia recovery stream 9 is reduced so less water is fed to the mixing device 13 for mixing therein.

Further, the proportion of the ammonia recovery stream 9 output to the mixing device 13 (instead of being sent to the tank 23) can also be adjusted to decrease the proportion of the ammonia recovery stream 9 being provided to the mixing device 13 so that more water as well as more ammonia from the scrubber 20 is being output to the storage tank 23 for retention therein and subsequent recycling back to the scrubber 20 for use therein to also reduce the amount of water being fed to the mixing device 13 so that the formed ammonia product stream 14 output from the mixing device can maintain a suitable content of ammonia and water (e.g. be between 99.2 wt % ammonia and 99.5 wt % ammonia and be between 0.5 wt % water and 0.2 wt % water, be between 99.4 wt % ammonia and 99.8 wt % ammonia and be between 0.6 wt % water and 0.2 wt % water etc.). At least one of decreasing the rate of scrubbing liquid being fed to the scrubber 30 via the scrubber feed conduit 28 and the adjustment of the proportion of the ammonia recovery stream 9 being sent to the mixing device 13 can be utilized to increase the amount of fluid stored in tank 23 and also avoid the water content within the ammonia product 14 being output from the mixing device 13 exceeding its pre-specified upper range value (e.g. 0.5 wt % water, 0.6 wt % water, 0.8 wt %, water, etc.). It should be appreciated that the decreased rate of output of fluid provided by the tank 23 can be provided by decreasing the pump's operation to drive a lesser flow of fluid out of tank 23 and/or adjusting valves within the scrubbing liquid return conduit 27 and/or scrubber feed conduit 28 to decrease the portion of the scrubbing fluid that is passed into scrubber feed conduit 28 and increase the flow of liquid returning to the tank via return conduit 27. To the extent water from the water supply was utilized previously, the water flow rate can also be stopped or reduced from the water supply 21 so that as much of the scrubbing liquid being used by the scrubber 20 as possible is provided by the tank 23 to have the fluid fed to the tank be fed so that the tank's level of scrubbing liquid retained therein is as low as possible without being completely empty or within a pre-selected low ammonia production storage tank filled threshold level range (e.g. at least 5% full and not more than 90% full, more than 5% full and no more than 85% full, etc.) during a low ammonia production time period while also feeding fluid to the mixing device 13 so it is able to output ammonia product stream 14 with ammonia and water within their pre-specified content ranges.

It should be appreciated that the providing of a lower rate of scrubbing liquid from the tank 23 can result in a decreased flow rate of liquid within the ammonia recovery stream 9 due to the decreased rate of liquid being fed to the scrubber 20. This decreased rate of overall liquid can help facilitate a decrease in water being ultimately fed to the mixing device 13 via the ammonia recovery stream 9 output from the scrubber 20. This decreased water output to the mixing device 13 can be performed such that the tank 23 can be filled with at least some of the ammonia recovery stream fluid output from the scrubber 20 to avoid providing too much water such that the ammonia product stream 14 output from the mixing device 13 has water and ammonia concentrations within their pre-specified content ranges (e.g. 99.8-99.5 wt % ammonia, 0.2-0.5 wt % water, 99.8-99.2 wt % ammonia, 0.2-0.8 wt % water, etc.). The use of tank 23 can also help allow this ammonia recovery stream fluid 9 to be captured and recycled so its ammonia is not lost and so that wastewater does not have to be formed (and subsequently treated via a wastewater treatment facility).

Thereafter, the at-issue weather condition may change so that renewable power production may increase and return to a level that allows ammonia production from ammonia manufacturing to ramp significantly to a high level such that the flow rate of liquid ammonia from the ammonia manufacturing product stream(s) 3 increases to above a pre-selected threshold (e.g. 100% capacity, 90%-100% of the production capacity rate, 80%-100% of the production capacity rate, etc.) as indicated in step S2 of FIG. 3, for example. This higher rate of the liquid ammonia output in the ammonia product stream(s) 3 can be, for example, the first flow rate of liquid ammonia that is fed to the mixing device 13 discussed above or a third flow rate of liquid ammonia that is fed to the mixing device 13 that is higher than the second flow rate that may occur when the ammonia production is at a lower level.

At this higher first flow rate or higher third flow rate of ammonia from the ammonia manufacturing 2, the ammonia product stream(s) 3 can be mixed with the ammonia recovery stream 9 and again receive the first flow rate of water or receive a third flow rate from the ammonia recovery stream 9 while still permitting the product stream 14 output from the mixing device to have an ammonia content within a pre-selected ammonia concentration (e.g. 99.2 wt % ammonia, or 99.4 wt % ammonia, etc.). The amount of scrubbing liquid output from the tank 23 to the scrubber 20 can be increased when this operational condition has been determined to exist or is detected to increase the rate at which the tank fluid is being emptied to work to provide more of the liquid that includes water and ammonia from within the tank to the scrubber and the proportion of the ammonia recovery stream 9 output to the mixing device 13 (instead of being sent to the tank 23) can also be adjusted to increase the proportion of the ammonia recovery stream 9 being provided to the mixing device 13 so that more water as well as more ammonia from the scrubber 20 is being output to the mixing device 13 for mixing therein to form the product stream 14 for being output to ammonia storage 15. At least one of increasing the rate of scrubbing liquid being fed to the scrubber 20 from the tank 23 via the scrubber feed conduit 28 and the adjustment of the proportion of the ammonia recovery stream 9 being sent to the mixing device 13 can be utilized to decrease the amount of fluid stored in tank 23 and also increase the water content within the ammonia product 14 being output from the mixing device 13. It should be appreciated that the increased rate of output of fluid provided by the tank 23 can be provided by increasing the pump's operation to drive a greater flow of fluid and/or adjusting valves within the scrubbing liquid return conduit 27 and/or scrubber feed conduit 28 to increase the portion of the scrubbing fluid that is passed into scrubber feed conduit 28 and decrease the flow of liquid returning to the tank via return conduit 27.

The amount of liquid scrubbing fluid from the tank 23 that is output to the scrubber 20 can be returned to the first flow rate or can be at a third rate that can be a high rate of output to help empty the tank at a faster rate to increase its capacity to store fluid from the ammonia recovery stream 9 output from the scrubber 20 during lower ammonia production time periods that may subsequently occur within a production cycle of the plant 1. The pump 25 and the one or more valves 33 of the water feed for the water supply 21 and the scrubber feed conduit 28 can be adjusted to facilitate the flow of the liquid scrubbing fluid from the tank 23 to the scrubber 20. The flow rate of the liquid scrubbing fluid from the tank 23 to the scrubber 20 (and use of water from water supply 21 as may be needed for supplementing that flow of scrubbing liquid to a flow rate needed by the scrubber 20) can be adjusted to help to adjust the tank capacity of scrubbing liquid being retained within the tank 23 so the tank's level of scrubbing liquid retained therein is as low as possible or within a pre-selected high ammonia production capacity storage tank filled threshold level range (e.g. at least 5% full and not more than 20% full, at least 5%-10% full, between 5% full and 10% full, more than 5% full and less than 25% full, etc.) while also permitting the mixing device 13 to receive fluid and be able to output ammonia product stream 14 with ammonia and water within their pre-specified content ranges during this high ammonia production time period of operation.

At some point in time after the change of step S2 occurs, the operational output of ammonia from the ammonia manufacturing 2 can yet again decrease to the second flow rate or a fourth flow rate that is lower than the first flow rate and/or also lower than the third flow rate (e.g. drop to a substantially lower output rate of 10% operational capacity of the ammonia manufacturing 2 or in a range of 10% to 30% of the operational capacity for the ammonia manufacturing 2 or in a range of less than 60% of the operational capacity of the ammonia manufacturing 2, etc.). This can occur as a consequence of reduced power availability from renewable power sources (solar, wind, etc.) that may arise due to weather conditions, for example. As a result, the liquid ammonia flow rate of the ammonia product stream(s) 3 fed to the mixing device 13 can be below a pre-selected threshold. Such a condition can be appreciated from step S3 of FIG. 3, for example.

In response to the detection or determination of such a situation, the flow of the scrubbing liquid that is output from the tank 23 to the scrubber 20 can be adjusted so at least some of the fluid of the ammonia recovery stream 9 is fed to the tank 23 or there is an increase in the portion of the ammonia recovery stream 9 that is fed to the storage tank 23.

At this lower fourth flow rate or the second flow rate of ammonia from the ammonia manufacturing 2, the ammonia product stream(s) 3 can be mixed with the ammonia recovery stream 9 and receive a fourth flow rate of water or again receive the second flow rate of water from the ammonia recovery stream 9 while still permitting the product stream 14 output from the mixing device to have an ammonia content within a pre-selected ammonia concentration range (e.g. 99.2 wt % ammonia to 99.8 wt % ammonia, 99.4 wt % ammonia to 99.8 wt % ammonia, 99.6 wt % ammonia to 99.8 wt % ammonia, etc.). The amount of scrubbing liquid output from the tank 23 to the scrubber 20 can be decreased when this operational condition has been determined to exist or detected to decrease the rate at which the tank fluid is being emptied from the tank 23 to work to provide less of the liquid that includes water and ammonia from within the tank 23 to the scrubber 20 so that the overall flow of water within the ammonia recovery stream 9 is reduced so less water is fed to the mixing device 13 for mixing therein.

Further, the proportion of the ammonia recovery stream 9 output to the mixing device 13 (instead of being sent to the tank 23) can also be adjusted to decrease the proportion of the ammonia recovery stream 9 being provided to the mixing device 13 so that more water as well as more ammonia from the scrubber 20 is being output to the storage tank 23 for retention therein and subsequent recycling back to the scrubber 20 for use therein to also reduce the amount of water being fed to the mixing device 13 so that the formed ammonia product stream 14 output from the mixing device 13 can maintain a suitable content of ammonia and water (e.g. be between 99.2 wt % ammonia and 99.5 wt % ammonia and be between 0.5 wt % water and 0.2 wt % water, etc.). At least one of decreasing the rate of scrubbing liquid being fed to the scrubber 20 via the scrubber feed conduit 28 and the adjustment of the proportion of the ammonia recovery stream 9 being sent to the mixing device 13 can be utilized to increase the amount of fluid stored in tank 23 and also avoid the water content within the ammonia product 14 being output from the mixing device 13 exceeding its pre-specified upper range value (e.g. 0.5 wt % water, 0.6 wt % water, 0.8 wt % water, etc.).

It should be appreciated that the decreased rate of output of fluid provided by the tank 23 can be provided by decreasing the pump's operation to drive a lesser flow of fluid out of tank 23 and/or adjusting valves within the scrubbing liquid return conduit 27 and/or scrubber feed conduit 28 to decrease the portion of the scrubbing fluid that is passed into scrubber feed conduit 28 and increase the flow of liquid returning to the tank via return conduit 27. To the extent water from the water supply was utilized previously, the water flow rate can also be stopped or reduced from the water supply 21 so that as much of the scrubbing liquid being used by the scrubber 20 as possible is provided by the tank 23 to have the fluid fed to the tank be fed so that the tank's level of scrubbing liquid retained therein is as low as possible or within a pre-selected low ammonia production storage tank filled threshold level range (e.g. at least 5% full and not more than 85% full, more than 5% full and no more than 90% full, at least 5% full and not more than 80% full, etc.) during a low ammonia production time period while also permitting the mixing device 13 to be able to receive fluid from the scrubber 20 and be able to output ammonia product stream 14 with ammonia and water within their pre-specified content ranges.

Thereafter, the at-issue weather condition may again change after the condition of step S3 has occurred so that renewable power production may yet again increase and return to a level that allows ammonia production from ammonia manufacturing to ramp significantly to a high level such that the flow rate of liquid ammonia from the ammonia manufacturing product stream(s) 3 increases to above a pre-selected threshold (e.g. 100% capacity or 80%-100% of the production capacity rate, etc.) as indicated in step S4 of FIG. 3, for example. This higher rate of the liquid ammonia output in the ammonia product stream(s) 3 can be, for example, the first or third flow rate of liquid ammonia that is fed to the mixing device 13 discussed above or a fifth flow rate of liquid ammonia that is fed to the mixing device 13 that is higher than the second flow rate or fourth flow rate that may occur when the ammonia production is at a lower level.

At this higher first flow rate, higher third flow rate, or higher fifth flow rate of ammonia from the ammonia manufacturing 2, the ammonia product stream(s) 3 can be mixed with the ammonia recovery stream 9 and yet again receive the first flow rate of water or receive the third flow rate of water or receive a fifth flow rate of water from the ammonia recovery stream 9 while still permitting the product stream 14 output from the mixing device 13 to have an ammonia content within a pre-selected ammonia concentration range (e.g. 99.2 wt % ammonia to 99.8 wt % ammonia, or 99.4 wt % ammonia to 99.8 wt % ammonia, etc.). The amount of scrubbing liquid output from the tank 23 to the scrubber 20 can be increased when this operational condition has been determined to exist or is detected to increase the rate at which the tank fluid is being emptied from the tank 23 to work to provide more of the liquid that includes water and ammonia from within the tank 23 to the scrubber 20 and the proportion of the ammonia recovery stream 9 output to the mixing device 13 (instead of being sent to the tank 23) can also be adjusted to increase the proportion of the ammonia recovery stream 9 being provided to the mixing device 13 so that more water as well as more ammonia from the scrubber 20 is being output to the mixing device 13 for mixing therein to form the product stream 14 for being output to ammonia storage 15. At least one of increasing the rate of scrubbing liquid being fed to the scrubber 20 via the scrubber feed conduit 28 and the adjustment of the proportion of the ammonia recovery stream 9 being sent to the mixing device 13 can be utilized to decrease the amount of fluid stored in tank 23 and also increase the water content within the ammonia product 14 being output from the mixing device 13. It should be appreciated that the increased rate of output of fluid provided by the tank 23 can be provided by increasing the pump's operation to drive a greater flow of fluid and/or adjusting valves within the scrubbing liquid return conduit 27 and/or scrubber feed conduit 28 to increase the portion of the scrubbing fluid that is passed into scrubber feed conduit 28 and decrease the flow of liquid returning to the tank via return conduit 27.

The amount of liquid scrubbing fluid from the tank 23 that is output to the scrubber 20 can be returned to the first rate or can be at the third rate or can be at a fifth rate that can be a high rate of output to help empty the tank 23 (e.g. reduce the filled capacity of the tank to a lower level that is near or at a pre-selected minimum filled capacity level) at a faster rate to increase its capacity to store fluid from the ammonia recovery stream 9 output from the scrubber 20 during lower ammonia production time periods within a production cycle of the plant. The pump 25 and the one or more valves 33 of the water feed for the water supply 21 and the scrubber feed conduit 28 can be adjusted to facilitate the flow of the liquid scrubbing fluid from the tank 23 to the scrubber 20. The flow rate of the liquid scrubbing fluid from the tank 23 to the scrubber 20 (and use of water from water supply 21 as may be needed for supplementing that flow of scrubbing liquid to a flow rate needed by the scrubber 20) can be adjusted to help to adjust the tank capacity of scrubbing liquid being retained within the tank so the tank's level of scrubbing liquid retained therein is as low as possible or within a pre-selected high ammonia production capacity storage tank filled threshold level range (e.g. at least 5% full and not more than 25% full, more than 5% and less than 20%, at least 5%-10% full, etc.) while also providing fluid to the mixing device 13 so it is able to output ammonia product stream 14 with ammonia and water within their pre-specified content ranges during this high ammonia production time period of operation.

As indicated in FIG. 3, the production cycle ramping up to higher ammonia production levels and ramping down to substantially lower ammonia production cycles can repeatedly occur (e.g. arrow indicating Step S4 can return to Step S1 in FIG. 3). The controller CTRL, sensors 31, valves 33, storage tank 23 and scrubber 20 can be operated to adjust to the ammonia production changes so that no wastewater is generated by the process. Instead, ammonia recovery liquid of the ammonia recovery stream 9 is either mixed in mixing device 13 or retained in tank 23 for being recycled back to the scrubber 20. This approach can also help an operator adjust operations to recover as much ammonia as possible from the vent stream(s) 5 output from the ammonia manufacturing process to minimize ammonia losses that may occur from the ammonia manufacturing process for forming an ammonia product stream 14 for subsequent ammonia storage 15 and use.

The scrubber 20 can be configured to operate so a minimum scrubbing liquid flow rate of the scrubbing liquid is to be fed to the scrubber 20 for scrubbing of the vent gas fed therein (via the tank 23 and/or water supply 21). The scrubbing liquid fed to the scrubber 20 can be adjusted so it can be changed from this minimum flow rate to higher flow rates as discussed above. The scrubbing liquid fed to the scrubber 20 can also be adapted so that the flow rate of the scrubbing liquid fed to the scrubber 20 does not fall below the pre-selected or pre-defined minimum threshold scrubbing liquid flow rate (e.g. a flow rate that allows the scrubber 20 to operate at 50% of its operational capacity for liquid flow being passed through the scrubber 20, or a flow rate that allows the scrubber 20 to operate at 40%-60% of its operational capacity for liquid flow being passed through the scrubber 20, etc.). As can be appreciated from the above, the higher flow rates of the scrubbing liquid fed to the scrubber 20 can be utilized to provide additional, higher flow rates of the ammonia recovery stream 9 so that more of the liquid of the ammonia recovery stream 9 is fed to the mixing device 13 for mixing therein to form the product stream 14 so that more water content within this stream is provided to help empty tank 23, avoid formation of wastewater that needs to be disposed of or treated, while still having the ammonia product stream 14 include ammonia within a pre-selected ammonia content range (e.g. 99.2 wt % ammonia to 99.8 wt % ammonia or other exemplary pre-selected range discussed herein etc.). Further, use of the tank 23 to store for subsequent use a portion of the ammonia recovery stream 9 can permit the minimum flow rate of the scrubbing liquid to be provided to the scrubber 20 during low ammonia production time periods and allow the liquid to be stored for subsequent recycling back to the scrubber 20 to minimize or avoid wastewater formation and also avoid loss of the ammonia obtained via the scrubber's treatment of the vent gas from the ammonia manufacturing 2 to recover ammonia from the vent gas.

It should also be appreciated that operation of vent stream treatment device 7 can be adapted so that the liquid level within the tank 23 is controlled so that the liquid level stays between a pre-selected minimum capacity and a pre-selected maximum capacity. As discussed above, a pre-selected minimum capacity can be 5%-10% of the tank capacity and a pre-selected maximum capacity can be no more than 85% of the tank capacity or no more than 80% of the tank capacity. Other embodiments may utilize other minimum and maximum thresholds for meeting a particular set of design criteria as well. The pre-selected minimum capacity can be set to a level that can maintain the net positive suction head (available), which can also be referred to as “NPSHa”, for pump 25, for example. The pre-selected minimum capacity can be set so that a sufficient seal for the pump 25 is provided via the liquid level within the tank. The pre-selected maximum capacity threshold for the tank 25 can be selected to avoid overfilling of the tank or over pressurization condition within the tank 23. The pre-selected maximum capacity threshold for the tank can be determined or selected to help avoid a situation where the tank becomes over filled or experiences an over pressurization condition that could cause damage to the tank or other elements (e.g. could contribute to creation of a leakage problem, etc.).

As mentioned above, there can be a small chance that a weather condition or other event could occur that requires operation of ammonia manufacturing to occur at a low ammonia production capacity for an unusually long period of time. In such a condition, it may become necessary to empty the tank 23 to its pre-selected minimum capacity range (e.g. reduce the liquid within the tank 23 so that the liquid within the tank is only 5%-10% of the capacity of the tank, etc.). This reduction can be provided so additional scrubbing liquid from the ammonia recovery stream 9 can be fed into the tank 23 for subsequent use as a scrubbing liquid to be fed to the scrubber 20. The apparatus can be adapted to permit emptying of the tank 23 to have scrubbing fluid sent to a water treatment facility or to a transportation device 40 for transport so that the tank can be emptied and tank capacity for additional scrubbing liquid to be increased. Such a process of emptying the tank 23 can occur while some scrubbing fluid is still being provided to the scrubber 20 via adjustment of control valves 33 in the wastewater treatment feed conduit 43 for feeding liquid scrubbing fluid within the tank 23 to a wastewater treatment facility and/or the transportation vehicle feed conduit 41 for feeding liquid scrubbing fluid from the tank 23 to a transport vessel 40 of a vehicle to be transported off-site to another location for subsequent use or treatment.

While embodiments of the apparatus may be designed to accommodate such an operational occurrence, the typical operation of the apparatus can be provided so that wastewater is not typically generated. Instead, the combination of the tank 23 and scrubber 20 can be arranged and provided to avoid wastewater formation. Embodiments can also permit the scrubber 20 to accommodate large variations in ammonia production from ammonia manufacturing 2 (e.g. ranging from 5%-10% of production capacity to 80%-100% production capacity or ranging from 5%-30% of production capacity to 80%-100% production capacity, etc.) that can occur as a consequence of the plant 1 relying on one or more renewable power sources to power its operation while ammonia product having ammonia within a pre-selected ammonia concentration range is providable. For instance (and as can be appreciated from the above discussion of exemplary embodiments), the scrubber 20 and the scrubbing fluid storage tank 23 can be positioned and arranged so that the portion of the ammonia recovery stream 9 feedable to the scrubbing fluid storage tank 23 and the portion of the ammonia recovery stream feedable to the mixing device 13 are adjustable so that the portion of the ammonia recovery stream 9 fed to the scrubbing fluid storage tank 23 decreases when the at least one ammonia product stream 3 received from the ammonia manufacturing 2 is at a first flow rate and the portion of the ammonia recovery stream 9 fed to the scrubbing fluid storage tank 23 increases when the at least one ammonia product stream 3 received from the ammonia manufacturing 2 is at a second flow rate that is below the first flow rate where the first flow rate for the at least one ammonia product stream 3 received from the ammonia manufacturing 2 is a flow rate at which the ammonia manufacturing operates at a range of 80% capacity to 100% capacity and the second flow rate for the at least one ammonia product stream 3 received from the ammonia manufacturing 2 is a flow rate at which the ammonia manufacturing 2 operates at a range of 5% capacity to 25% capacity. As another example, the scrubber 20 and the scrubbing fluid storage tank 23 can be positioned and arranged so that a flow rate for the portion of the ammonia recovery stream 9 feedable to the scrubbing fluid storage tank 23 is adjustable so that the flow rate of the portion of the ammonia recovery stream 9 fed to the scrubbing fluid storage tank 23 decreases when the at least one ammonia product stream 3 received from the ammonia manufacturing 2 by mixing device 13 is at a first flow rate and the flow rate of the portion of the ammonia recovery stream 9 fed to the scrubbing fluid storage tank 23 increases when the at least one ammonia product stream 3 received from the ammonia manufacturing 2 is at a second flow rate that is below the first flow rate where the first flow rate for the at least one ammonia product stream 3 received from the ammonia manufacturing 2 is a flow rate at which the ammonia manufacturing 2 operates at a range of 80% capacity to 100% capacity and the second flow rate for the at least one ammonia product stream 3 received from the ammonia manufacturing 2 is a flow rate at which the ammonia manufacturing 2 operates at a range of 5% capacity to 25% capacity.

Embodiments of our apparatus, system, and process can therefore provide significant improvements in operational flexibility, significantly improved profitability by reducing costs of wastewater treatment as well as improving ammonia recovery from vent gas(es) output from ammonia manufacturing 2, and greatly reducing the environmental impact that ammonia formation and/or hydrogen generation industrial processes may have.

It should be appreciated that modifications to the embodiments explicitly shown and discussed herein can be made to meet a particular set of design objectives or a particular set of design criteria. For instance, the arrangement of valves, piping, and other conduit elements (e.g. conduit connection mechanisms, tubing, seals, etc.) for interconnecting different units of the plant for fluid communication of the flows of fluid between different units can be arranged to meet a particular plant layout design that accounts for available area of the plant, sized equipment of the plant, and other design considerations. As another example, the flow rate, pressure, and temperature of the fluid passed through the various apparatus or system elements can vary to account for different design configurations and other design criteria.

Embodiments of a plant, the apparatus for reducing or avoiding creation of wastewater when treating one or more streams output from ammonia manufacturing unit, process for reducing or avoiding creation of wastewater when treating one or more streams output from ammonia manufacturing, and/or system for reducing or avoiding creation of wastewater when treating one or more streams output from ammonia manufacturing can each be configured to include process control elements positioned and configured to monitor and control operations (e.g. temperature and pressure sensors, flow sensors, an automated process control system having at least one work station that includes a processor, non-transitory memory and at least one transceiver for communications with the sensor elements, valves, and controllers for providing a user interface for an automated process control system that may be run at the work station and/or another computer device of the plant, etc.).

As another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of the process, apparatus, system and methods of making and using the same have been shown and described above, it is to be distinctly understood that the invention is not limited thereto but may be otherwise variously embodied and practiced within the scope of the following claims.

What is claimed is:

1. An apparatus for reducing or avoiding creation of wastewater when treating one or more streams output from ammonia manufacturing, the apparatus comprising:
a scrubber positionable to receive at least one vent gas stream from the ammonia manufacturing, the scrubber configured to treat vent gas of the at least one vent gas stream via a scrubbing liquid that is feedable to the scrubber to remove ammonia (NH₃) from the vent gas and output an ammonia recovery stream comprising a liquid that includes water and ammonia and also output at least one waste gas stream;
a scrubbing fluid storage tank positioned and configured to receive a portion of the ammonia recovery stream output from the scrubber to retain the portion of the ammonia recovery stream therein and subsequently feed the portion of the ammonia recovery stream to the scrubber as the scrubbing liquid.

2. The apparatus of claim 1, wherein a scrubbing fluid storage tank conduit is positioned between the scrubber and the scrubbing fluid storage tank so that the portion of the ammonia recovery stream is feedable to the scrubbing fluid storage tank and a scrubber feed conduit is positioned between the scrubber and the scrubbing fluid storage tank so that the portion of the ammonia recovery stream is feedable from the scrubbing fluid storage tank to the scrubber as the scrubbing liquid.

3. The apparatus of claim 2, comprising:
a pump connected to the scrubber feed conduit so that the scrubbing liquid is outputtable from the scrubbing fluid storage tank to the scrubber.

4. The apparatus of claim 1, wherein the scrubber and the scrubbing fluid storage tank are positioned and arranged so that wastewater is not formed from operation of the scrubber.

5. The apparatus of claim 1, comprising:
a mixing device positioned to receive at least one ammonia product stream from the ammonia manufacturing, the at least one ammonia product stream comprising a liquid having ammonia at a concentration of between 99.2 weight percent (wt %) ammonia to 99.8 wt % ammonia;
the mixing device also positioned to receive a portion of the ammonia recovery stream from the scrubber to mix with the at least one ammonia product stream and output an ammonia product stream comprising a liquid having ammonia between 99.2 wt % ammonia and 99.8 wt % ammonia and water between 0.2 wt % water and 0.8 wt % water.

6. The apparatus of claim 5, also comprising:
ammonia storage positioned to receive the ammonia product stream output from the mixing device for storage therein.

7. The apparatus of claim 1, comprising:
a mixing device positioned to receive a portion of the ammonia recovery stream from the scrubber to mix with the at least one ammonia product stream received from the ammonia manufacturing and output an ammonia product stream comprising a liquid having ammonia within a pre-selected ammonia concentration range and water within a pre-selected water concentration range.

8. The apparatus of claim 1, wherein:
the scrubber and the scrubbing fluid storage tank are positioned such that a portion of the ammonia recovery stream output from the scrubber is feedable to a mixing device to mix with the at least one ammonia product stream received from the ammonia manufacturing and output an ammonia product stream comprising a liquid having ammonia within a pre-selected ammonia concentration range and water within a pre-selected water concentration range;
the scrubber and the scrubbing fluid storage tank also being positioned and arranged so that the portion of the ammonia recovery stream feedable to the scrubbing fluid storage tank and the portion of the ammonia recovery stream feedable to the mixing device are adjustable so that the portion of the ammonia recovery stream fed to the scrubbing fluid storage tank decreases when the at least one ammonia product stream received from the ammonia manufacturing is at a first flow rate and the portion of the ammonia recovery stream fed to the scrubbing fluid storage tank increases when the at least one ammonia product stream received from the ammonia manufacturing is at a second flow rate that is below the first flow rate; and
the first flow rate for the at least one ammonia product stream received from the ammonia manufacturing being a flow rate at which the ammonia manufacturing operates at a range of 80% capacity to 100% capacity and the second flow rate for the at least one ammonia product stream received from the ammonia manufacturing being a flow rate at which the ammonia manufacturing operates at a range of 5% capacity to 25% capacity.

9. The apparatus of claim 1, wherein:
the scrubber and the scrubbing fluid storage tank are positioned such that a portion of the ammonia recovery stream output from the scrubber is feedable to a mixing device to mix with the at least one ammonia product stream received from the ammonia manufacturing and output an ammonia product stream comprising a liquid having ammonia within a pre-selected ammonia concentration range and water within a pre-selected water concentration range;
the scrubber and the scrubbing fluid storage tank also being positioned and arranged so that a flow rate for the portion of the ammonia recovery stream feedable to the scrubbing fluid storage tank is adjustable so that the flow rate of the portion of the ammonia recovery stream fed to the scrubbing fluid storage tank decreases when the at least one ammonia product stream received from the ammonia manufacturing is at a first flow rate and the flow rate of the portion of the ammonia recovery stream fed to the scrubbing fluid storage tank increases when the at least one ammonia product stream received from the ammonia manufacturing is at a second flow rate that is below the first flow rate; and
the first flow rate for the at least one ammonia product stream received from the ammonia manufacturing being a flow rate at which the ammonia manufacturing operates at a range of 80% capacity to 100% capacity and the second flow rate for the at least one ammonia product stream received from the ammonia manufacturing being a flow rate at which the ammonia manufacturing operates at a range of 5% capacity to 25% capacity.

10. The apparatus of claim 1, comprising:
a vapor conduit positioned between the scrubbing fluid storage tank and the scrubber to feed vapor from the scrubbing fluid storage tank to the scrubber.

11. The apparatus of claim 10, wherein:
the vapor conduit is connected to a vent stream feed line for feeding that vapor to the scrubber along with the at least one vent gas stream; or
the vapor conduit is connected to the scrubber for feeding the vapor from the scrubbing fluid storage tank at an inlet to the scrubber that is separate from an inlet of a vent stream feed line that provides the at least one vent gas stream to the scrubber.

12. A method for reducing or avoiding creation of wastewater when treating one or more streams output from an ammonia manufacturing process, the method comprising:
feeding at least one vent gas stream from the ammonia manufacturing process to a scrubber configured to treat vent gas of the at least one vent gas stream via a scrubbing liquid that is feedable to the scrubber to remove ammonia (NH₃) from the vent gas and output an ammonia recovery stream comprising a liquid that includes water and ammonia and also output at least one waste gas stream;
adjustably feeding a portion of the ammonia recovery stream to a scrubbing fluid storage tank based on a flow rate of ammonia product output from the ammonia manufacturing process;
feeding the portion of the ammonia recovery stream from the scrubbing fluid storage tank to the scrubber as the scrubbing liquid.

13. The method of claim 12, wherein the adjustably feeding of the portion of the ammonia recovery stream to the scrubbing fluid storage tank based on the flow rate of ammonia product output from the ammonia manufacturing process comprises:
adjusting the portion of the ammonia recovery stream fed to the scrubbing fluid storage tank so that the portion of the ammonia recovery stream fed to the scrubbing fluid storage tank decreases when the flow rate of ammonia product output from the ammonia manufacturing process is within a first flow rate range; and
adjusting the portion of the ammonia recovery stream fed to the scrubbing fluid storage tank so that the portion of the ammonia recovery stream fed to the scrubbing fluid storage tank increases when the flow rate of ammonia product output from the ammonia manufacturing process is within a second flow rate range that is below the first flow rate range; and
the first flow rate range for the flow rate of ammonia product output from the ammonia manufacturing process is a flow rate at which the ammonia manufacturing process operates at a range of 80% capacity to 100% capacity and the second flow rate range for the flow rate of ammonia product output from the ammonia manufacturing process being a flow rate range at which the ammonia manufacturing process operates at a range of 5% capacity to 25% capacity.

14. The method of claim 13, comprising:
feeding a portion of the ammonia recovery stream output from the scrubber to a mixing device to mix with the ammonia product output from the ammonia manufacturing process to output an ammonia product stream comprising a liquid having ammonia within a pre-selected ammonia concentration range and water within a pre-selected water concentration range.

15. The method of claim 12, wherein the adjustably feeding of the portion of the ammonia recovery stream to the scrubbing fluid storage tank based on the flow rate of ammonia product output from the ammonia manufacturing process comprises:
adjusting a flow rate for the portion of the ammonia recovery stream feedable to the scrubbing fluid storage tank so that the flow rate of the portion of the ammonia recovery stream fed to the scrubbing fluid storage tank decreases when the flow rate of ammonia product output from the ammonia manufacturing process is within a first flow rate range; and
adjusting the flow rate for the portion of the ammonia recovery stream feedable to the scrubbing fluid storage tank so that the flow rate of the portion of the ammonia recovery stream fed to the scrubbing fluid storage tank increases when the flow rate of ammonia product output from the ammonia manufacturing process is within a second flow rate range; and
the first flow rate range for the flow rate of ammonia product output from the ammonia manufacturing process is a flow rate at which the ammonia manufacturing process operates at a range of 80% capacity to 100% capacity and the second flow rate range for the flow rate of ammonia product output from the ammonia manufacturing process is a flow rate range at which the ammonia manufacturing process operates at a range of 5% capacity to 25% capacity.

16. The method of claim 15, comprising:
feeding a portion of the ammonia recovery stream output from the scrubber to a mixing device to mix with the ammonia product output from the ammonia manufacturing process to output an ammonia product stream comprising a liquid having ammonia within a pre-selected ammonia concentration range and water within a pre-selected water concentration range.

17. The method of claim 12, comprising:
feeding a vapor from the scrubbing fluid storage tank to the scrubber.

18. The method of claim 17, wherein the feeding of the vapor from the scrubbing fluid storage tank to the scrubber comprises:
feeding the vapor from the scrubbing fluid storage tank to a vent stream feed line for feeding that vapor to the scrubber along with the at least one vent gas stream; or
feeding the vapor from the scrubbing fluid storage tank to the scrubber via an inlet to the scrubber that is separate from an inlet of a vent stream feed line that provides the at least one vent gas stream to the scrubber.

19. The method of claim 12, comprising:
feeding at least one ammonia product stream from the ammonia manufacturing process to a mixing device, the at least one ammonia product stream comprising a liquid having ammonia at a concentration of between 99.2 weight percent (wt %) ammonia to 99.8 wt % ammonia;
feeding a portion of the ammonia recovery stream from the scrubber to the mixing device to mix with the at least one ammonia product stream and output an ammonia product stream comprising a liquid having ammonia between 99.2 wt % ammonia and 99.8 wt % ammonia and water between 0.2 wt % water and 0.8 wt % water.

20. The method of claim 19, wherein the scrubber and the scrubbing fluid storage tank are positioned and arranged so that wastewater is not generated from operation of the scrubber during operation of the method.
